(19) United States
(12) Patent Application Publication
(10) Pub. No.: US 2026/0238854 A1
(43) Pub. Date: Aug. 13, 2026

(54) IMAGE PROCESSING APPARATUS AND OPERATION METHOD THEREOF

(71) Applicant: Samsung Electronics Co., Ltd., Suwon-si (KR)

(72) Inventors: Jaesung PARK, Suwon-si (KR); Sanghun KIM, Suwon-si (KR)

(21) Appl. No.: 19/531,309

(22) Filed: Feb. 5, 2026

Related U.S. Application Data
(63) Continuation of application No. PCT/KR2026/001915, filed on Feb. 2, 2026.

(30) Foreign Application Priority Data
Feb. 11, 2025 (KR) 10-2025-0017511

(51) Int. Cl. H04N 21/462; H04N 21/44; H04N 21/442

(52) U.S. Cl. CPC H04N 21/4621; H04N 21/44008; H04N 21/44209

(57) ABSTRACT

An image processing apparatus includes memory, at least one first processor, and at least one second processor configured to perform image processing, wherein the image processing apparatus obtains input source information and a quality value of an input image, identifies quality statistic data of the input source information of the input image, obtains information about one or more models stored in identified quality statistic data, controls the at least one second processor to assign resources of the second processor to the one or more models, based on the information about the one or more models, loads, based on the information about the one or more models, onto the at least one second processor, a parameter dataset of the one or more models, and obtains an output image obtained by image-processing the input image, through the one or more models executed by the at least one second processor.

### CROSS-REFERENCE TO RELATED APPLICATIONS

This application is a continuation of International Application No. PCT/KR2026/001915 designating the United States, filed on February 2, 2026, in the Korean Intellectual Property Receiving Office and claiming priority to Korean Patent Application No. 10-2025-0017511, filed on February 11, 2025, in the Korean Intellectual Property Office, the disclosures of each of which are incorporated by reference herein in their entireties.

### BACKGROUND

### Field

The disclosure relates to the field of image processing, and for example, to an image processing apparatus and operation method of the image processing to improve image quality of the image.

### Description of Related Art

In the fields of image processing and computer vision, a high level of performance improvement has been achieved that was not previously possible, using artificial intelligence (AI). However, AI-based image processing algorithms require a large amount of computations. Recently, along with the making the image processing algorithms more lightweight, an on-device scheme that performs AI-based image processing within a device has been realized through performance improvement and optimization of hardware for computations of the image processing algorithms. The on-device scheme indicates a scheme in which an AI-based algorithm is directly driven on a device itself, such as a smartphone, a tablet computer, or an Internet of Things (IoT) device, rather than on a cloud server.

For example, an on-device operation using a processing unit is becoming widely used as performance of processing units, which are specialized in image processing neural networks, improves.

### SUMMARY

An image processing apparatus according to an example embodiment of the disclosure includes: memory including at least one storage medium storing one or more instructions, at least one first processor, comprising processing circuitry, individually and/or collectively, configured to execute the one or more instructions, and at least one second processor, comprising processing circuitry, individually and/or collectively, configured to perform image processing.

According to an example embodiment of the disclosure, the one or more instructions, when executed by at least one first processor individually and/or collectively, may cause the image processing apparatus to obtain input source information and a quality value of an input image.

According to an example embodiment of the disclosure, the one or more instructions, when executed by at least one first processor, individually and/or collectively, may cause the image processing apparatus to identify quality statistic data corresponding to the input source information of the input image from among a plurality of pieces of quality statistic data indicating an accumulated frequency according to quality of an image input for each input source.

According to an example embodiment of the disclosure, the one or more instructions, when executed by at least one first processor, individually and/or collectively, may cause the image processing apparatus to obtain information about one or more models stored in the identified quality statistic data.

According to an example embodiment of the disclosure, the one or more instructions, when executed by at least one first processor, individually and/or collectively, may cause the image processing apparatus to, during a determined resource distribution interval, control the at least one second processor to assign resources of the at least one second processor to the one or more models, based on the information about the one or more models.

According to an example embodiment of the disclosure, the one or more instructions, when executed by at least one first processor, individually and/or collectively, may cause the image processing apparatus to, based on the information about the one or more models, load, onto the at least one second processor, a parameter dataset of the one or more models.

According to an example embodiment of the disclosure, the one or more instructions, when executed by at least one first processor individually, and/or collectively, may cause the image processing apparatus to obtain an output image obtained by image-processing the input image, through the one or more models executed by at least one second processor.

A method of operating an image processing apparatus, according to an example embodiment of the disclosure, includes: obtaining input source information and a quality value of an input image, identifying quality statistic data corresponding to the input source information of the input image from among a plurality of pieces of quality statistic data indicating an accumulated frequency according to quality of an image input for each input source, obtaining information about one or more models stored in the identified quality statistic data, during a determined resource distribution interval, controlling at least one second processor to assign resources of the at least one second processor to the one or more models, based on the information about the one or more models, based on the information about the one or more models, loading, onto the at least one second processor, a parameter dataset of the one or more models , and obtaining an output image obtained by image-processing the input image, through one or more models executed by at least one second processor.

A non-transitory computer-readable recording medium according to an example embodiment of the disclosure has recorded thereon a program which, when executed on a computer, cause an image processing apparatus to perform the method of an image processing apparatus.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example image processing process of an image processing apparatus, according to various embodiments.

FIG. 2A is a graph illustrating quality information of various images, according to various embodiments.

FIG. 2B is a diagram illustrating an example operation of obtaining quality statistic data from accumulated quality data of an image, according to various embodiments.

FIG. 3A is a diagram including graphs illustrating example quality statistic data for each input source and a model set mapped to each quality interval in the quality statistic data, according to various embodiments.

FIG. 3B is a diagram illustrating lookup tables of quality statistic data for each input source, according to various embodiments.

FIG. 4 is a diagram illustrating a storage in which parameter datasets for a plurality of models are pre-stored, according to various embodiments.

FIG. 5 is a flowchart of illustrating an example method of operating an image processing apparatus, according to various embodiments.

FIG. 6 is a diagram illustrating example operations in which an image processing apparatus distributes resources of a second processor for a model according to input source information and a quality value of an input image, and loads a parameter dataset, according to various embodiments.

FIG. 7 is a diagram illustrating example resource distribution and image processing operations between a first processor and a second processor, according to various embodiments.

FIG. 8 is a flowchart illustrating an example method of operating an image processing apparatus, according to various embodiments.

FIG. 9A is a diagram illustrating an example resource distribution interval determined according to various embodiments.

FIG. 9B is a diagram illustrating an example resource distribution interval determined according to various embodiments.

FIG. 10 is a block diagram illustrating an example configuration of an image processing apparatus for performing an image processing operation, according to various embodiments.

FIG. 11 is a flowchart of illustrating an example method of operating an image processing apparatus, according to various embodiments.

FIG. 12 is a block diagram illustrating an example configuration of an image processing apparatus for performing an image processing operation, according to various embodiments.

FIG. 13 is a diagram illustrating an example model set and a resource distribution proportion, which are different for each channel of an input image, according to various embodiments.

FIG. 14 is a diagram illustrating an example model set and a resource distribution proportion, which are different for each high-definition multimedia interface (HDMI), according to various embodiments.

FIG. 15 is a diagram illustrating an example model set and a resource distribution proportion, which are different for each network speed of streaming content, according to various embodiments.

FIG. 16 is a diagram illustrating an example model set and a resource distribution proportion, which are different for each quality of an input image, according to various embodiments.

FIG. 17 is a diagram illustrating an example operation in which an image processing apparatus determines a model set for each of a main image and an auxiliary image, according to various embodiments.

FIG. 18 is a block diagram illustrating an example configuration of an image processing apparatus according to various embodiments.

FIG. 19 is a block diagram illustrating an example configuration of an image processing apparatus according to various embodiments.

### DETAILED DESCRIPTION

Throughout the disclosure, the expression "at least one of a, b, or c" indicates only a, only b, only c, both a and b, both a and c, both b and c, all of a, b, and c, or variations thereof.

Hereinafter, various example embodiments of the disclosure will be described in greater detail with reference to the accompanying drawings. However, the disclosure may be implemented in various different forms and is not limited to the various embodiments of the disclosure described herein.

Terms used in the disclosure are described as general terms currently used in consideration of functions described in the disclosure, but the terms may have different meanings according to an intention of one of ordinary skill in the art, precedent cases, or the appearance of new technologies. Thus, the terms used herein should not be interpreted only by its name, but have to be defined based on the meaning of the terms together with the description throughout the disclosure.

The terms used in the disclosure are used to describe embodiments of the disclosure, and are not intended to limit the disclosure.

Throughout the disclosure, when a part is "connected" to another part, the part may not only be "directly connected" to the other part, but may also be "electrically connected" to the other part with another element in between.

"The" and similar directives used in the present disclosure, in particular, in claims, may indicate both singular and plural. Unless there is a clear description of an order of operations describing a method according to the disclosure, the operations described may be performed in a suitable order. The disclosure is not limited by the order of description of the described operations.

The phrases "an embodiment of the disclosure" or the like appearing in various places in this disclosure are not necessarily all referring to the same embodiment of the disclosure.

Various embodiments of the disclosure may be represented by functional block configurations and various processing operations. Some or all of these functional blocks may be implemented by various numbers of hardware and/or software configurations that perform particular functions. For example, the functional blocks of the disclosure may be implemented by one or more microprocessors or by circuitry for a certain function. Also, for example, the functional blocks of the disclosure may be implemented in various programming or scripting languages. The functional blocks may be implemented by algorithms executed in one or more processors. The disclosure may employ general techniques for electronic environment setting, signal processing, and/or data processing. Terms such as "mechanism", "element", "means", and "configuration" may be used widely and are not limited as mechanical and physical configurations.

A connection line or a connection member between components shown in drawings is merely a functional connection and/or a physical or circuit connection. In an actual device, connections between components may be represented by various functional connections, physical connections, or circuit connections that are replaceable or added.

Terms such as "unit", "-or/-er", and "module" described in the disclosure denote a unit that processes at least one function or operation, which may be implemented in hardware or software, or implemented in a combination of hardware and software.

In the disclosure, each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

In the disclosure, the term "user" denotes a person using an electronic device, and may include a consumer, an assessor, a viewer, an administrator, and an installation engineer. The term "manufacturer" or "provider" in the disclosure may denote a manufacturer that manufactures an electronic device and/or a component included in the electronic device.

In the disclosure, an "image" may include a still image, graphics, a picture, a frame, a moving image including a plurality of consecutive still images, or a video.

In the disclosure, a function related to "artificial intelligence (AI)" may be performed through a processor and memory. The processor may be configured as one or more processors. In this case, the one or more processors may be a general-purpose processor such as a central processing unit (CPU), an application processor (AP), or a digital signal processor (DSP), a dedicated graphics processor such as a graphics processing unit (GPU) or a vision processing unit (VPU), or a dedicated artificial intelligence processor such as a neural processing unit (NPU). The one or more processors may control input data to be processed according to predefined operation rules or an artificial intelligence model stored in memory. When the one or more processors are a dedicated artificial intelligence processor, the dedicated artificial intelligence processor may be designed with a hardware structure specialized for processing a specific artificial intelligence model.

In an embodiment of the disclosure, an "artificial intelligence model" may include a neural network model. The neural network model may include a plurality of neural network layers. Each of the neural network layers includes a plurality of weight values, and performs a neural network arithmetic operation via an arithmetic operation between an arithmetic operation result of a previous layer and the plurality of weight values. The plurality of weight values in each of the neural network layers may be optimized by a result of training an artificial intelligence model. For example, the plurality of weight values may be updated to reduce or minimize a loss value or a cost value obtained by the artificial intelligence model during the training process. An artificial neural network model may include, for example, and without limitation, a deep neural network (DNN), and for example, may include a convolutional neural network (CNN), a recurrent neural network (RNN), a restricted Boltzmann machine (RBM), a deep belief network (DBN), a bidirectional recurrent deep neural network (BRDNN), deep Q-networks, or the like, but is not limited thereto.

Hereinafter, the disclosure will be described in greater detail with reference to accompanying drawings.

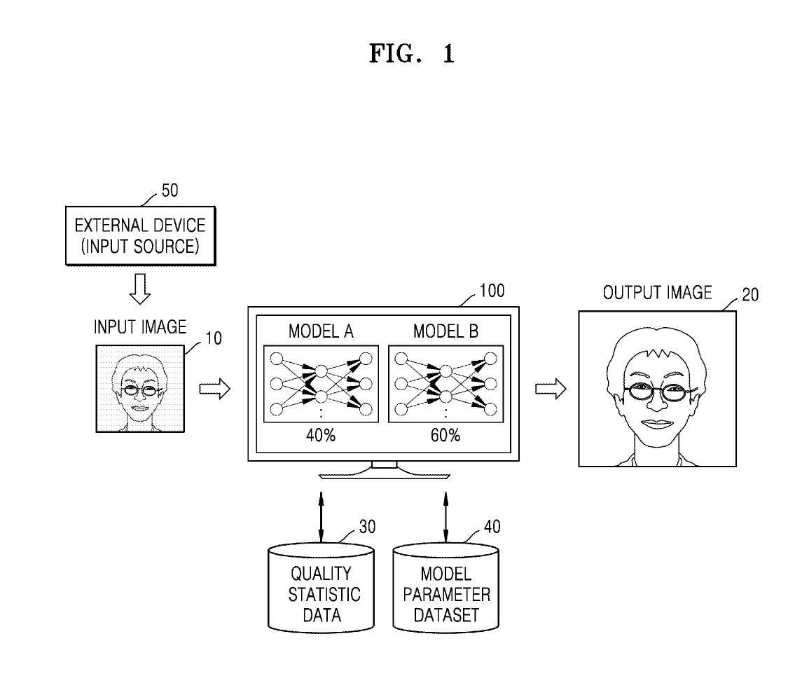

FIG. 1 is a diagram illustrating an example image processing process of an image processing apparatus, according to various embodiments.

Referring to FIG. 1, an image processing apparatus 100 of the disclosure may be an electronic device capable of processing and outputting an image. The image processing apparatus 100 may be realized in any form including a display. For example, the image processing apparatus 100 may be implemented as various electronic devices such as, for example, and without limitation, a mobile phone, a tablet personal computer (PC), a digital camera, a camcorder, a laptop computer, , a desktop computer, an electronic book terminal, a digital broadcasting terminal, a personal digital assistant (PDA), a portable multimedia player (PMP), a navigation device, an MP3 player, a wearable device, or the like.

The image processing apparatus 100 may receive, through an external device 50, various types of content generated by content providers and output the same. The content may include a still image, video content such as a moving image, audio content, subtitle content, and other additional information. The content provider may indicate a terrestrial broadcasting station, a cable broadcasting station, a satellite broadcasting station, an Internet protocol television (IPTV) service provider, an over-the-top (OTT) service provider, etc. which provides various types of content to a consumer. The external device 50 may be implemented as any type of source device, such as a PC, a set-top box (e.g., a terrestrial broadcasting set-top box, a cable broadcasting set-top box, a satellite broadcasting set-top box, an Internet broadcasting set-top box), a Blu-ray disc player, a mobile phone, a gaming console device, a home theater, an audio player, or a universal serial bus (USB). The external device 50 may be connected to the image processing apparatus 100 through an input/output unit, such as a high-definition multimedia interface (HDMI), and provide various types of content to the image processing apparatus 100. The external device 50 may be connected to the image processing apparatus 100 through a wireless/wired communication network, such as wireless fidelity (Wi-Fi) or a wireless local area network (WLAN), and provide various types of content to the image processing apparatus 100.

The image processing apparatus 100 according to an embodiment of the disclosure may process image quality of an image. The image processing apparatus 100 may perform image processing on video content with deteriorated quality. For example, the image processing apparatus 100 may perform image processing on an input image 10 and obtain an output image 20. For example, the image processing apparatus 100 may generate the output image 20 by applying, to the input image 10, at least one algorithm from among a noise removal algorithm, an upscaling algorithm, a sharpness enhancement algorithm, a contrast enhancement (CE) algorithm, a color correction algorithm, and a frame rate conversion (FRC) algorithm. However, the image processing performed by the image processing apparatus 100 is not limited to the above examples.

In the image processing apparatus 100 according to an embodiment of the disclosure, an image processing algorithm may be implemented as a neural network model. The image processing apparatus 100 may process arithmetic operations with respect to the neural network model using an on-device scheme in a device using a processing unit (hereinafter, an AI-dedicated processor) specialized in the arithmetic operations with respect to the neural network model. The on-device scheme indicates that the arithmetic operations are performed with respect to the neural network model using the AI-dedicated processor included in the device. The AI-dedicated processor may include resources (e.g., internal memory, an arithmetic operator, and a bandwidth) to process the arithmetic operations with respect to the neural network model.

In an embodiment of the disclosure, the image processing apparatus 100 may perform a selected image processing preparation operation to process an image input to the image processing apparatus 100. For example, in response to the image processing preparation operation, the image processing apparatus 100 may determine neural network models appropriate for processing an image, load, onto the AI-dedicated processor, parameter datasets of the determined neural network models, and distribute resources of the AI-dedicated processor (e.g., the image processing preparation operation). After the image processing preparation operation is performed, the image processing apparatus 100 may perform image processing on an input image.

In an embodiment of the disclosure, a type of neural network model required to process an image input to the image processing apparatus 100 may vary depending on the image. For example, because the image processing apparatus 100 receives an image through various external devices 50, quality of the image may vary and an appropriate neural network model may vary depending on the quality of the image. In an embodiment of the disclosure, the amount of resources (e.g., the internal memory, the arithmetic operator, and the bandwidth) required for the AI-dedicated processor to process the arithmetic operations with respect to the neural network model may be limited. Also, the amount of resources required for the arithmetic operations may vary depending on the neural network models.

Accordingly, it may take a considerable amount of time for the image processing apparatus 100 to determine appropriate neural network models for images of various qualities, load parameter datasets of the determined neural network models onto the AI-dedicated processor, and distribute resources of the AI-dedicated processor (e.g., the image processing preparation operation).

The image processing apparatus 100 according to an embodiment of the disclosure may pre-store quality statistic data 30 representing an accumulated frequency according to quality of an image for each input source. The quality statistic data 30 may represent the accumulated frequency according to the quality of the image for each input source. The quality statistic data 30 may be stored in the form of a lookup table including a plurality of pieces of quality statistic data representing accumulated frequencies of qualities of images input for each input source, but is not limited thereto. The quality statistic data 30 may further include, for each quality interval in quality statistic data for each input source, identification information about neural network models respectively mapped to quality intervals and resource distribution proportion information for the neural network models, but is not limited thereto. For example, the image processing apparatus 100 may pre-determine a combination of appropriate neural network models for each quality of an image provided by the external device 50, and store the same in the quality statistic data 30 of the image processing apparatus 100. For example, to quickly operate the neural network models for image processing, the image processing apparatus 100 may pre-determine an appropriate resource distribution proportion between the neural network models and store the same in the quality statistic data 30 of the image processing apparatus 100.

The image processing apparatus 100 according to an embodiment of the disclosure may pre-store model parameter datasets 40 for a plurality of neural network models. The model parameter dataset 40 may store pairs of identification information about a plurality of models and parameter datasets (e.g., weight data, kernels, and model architecture information) of the plurality of models. The parameter datasets of the plurality of models may be stored in different storage locations of the model parameter dataset 40.

The image processing apparatus 100 according to an embodiment of the disclosure may reduce a time required to prepare the image processing using the pre-stored quality statistic data 30 and model parameter dataset 40. In other words, the image processing apparatus 100 may pre-obtain information (e.g., combination information of neural network models, identification information, resource distribution proportion information of the neural network models, and storage locations of parameter datasets of the neural network models) about the neural network models required for image processing through the pre-stored quality statistic data 30 and model parameter dataset 40, load the parameter datasets of the neural network models onto the AI-dedicated processor based on the information about the neural network models, and distribute only the amount of resources of the AI-dedicated processor required for each neural network model. The image processing apparatus 100 may quickly distribute the resources and quickly load the neural network models using the information about a combination of neural network models, pre-stored in response to quality of an image, and the information about the resource distribution proportion between the neural network models. Accordingly, the image processing apparatus 100 may perform the image processing on an input image and quickly provide high quality image to a user.

For example, the image processing apparatus 100 may identify, using the quality statistic data 30, that an image processing function of a model A and an image processing function of a model B are required in response to quality of the input image 10. The image processing apparatus 100 may identify, using the quality statistic data 30, that required resource amounts (resource proportion) of the model A and the model B are respectively 40% and 60% of total resources of the AI-dedicated processor. The image processing apparatus 100 may identify where in the model parameter dataset 40 the parameter datasets of the model A and model B are pre-stored. The image processing apparatus 100 may control the AI-dedicated processor to distribute resources to the model A and the model B, based on the identification information of the neural network models and the resource distribution proportion information. The image processing apparatus 100 may load the parameter datasets of the model A and model B onto the AI-dedicated processor, based on the storage location information of the parameter datasets. After the image processing preparation operation, the image processing apparatus 100 may perform the image processing on the input image 10 to obtain the output image 20.

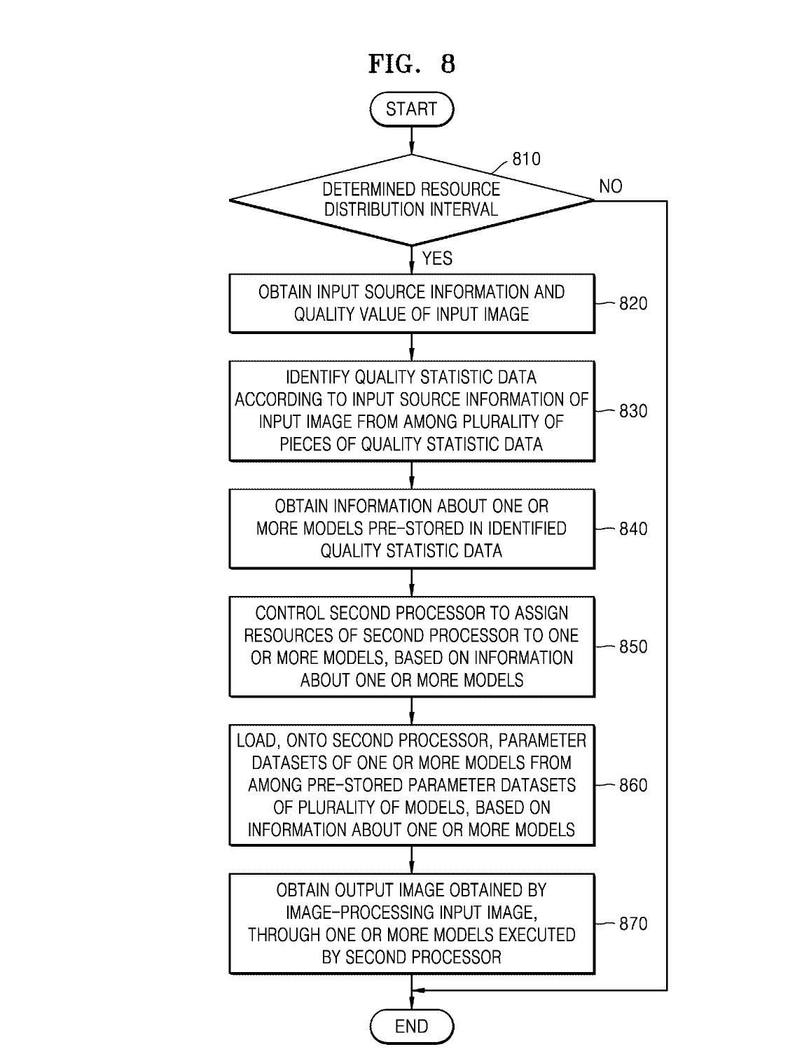

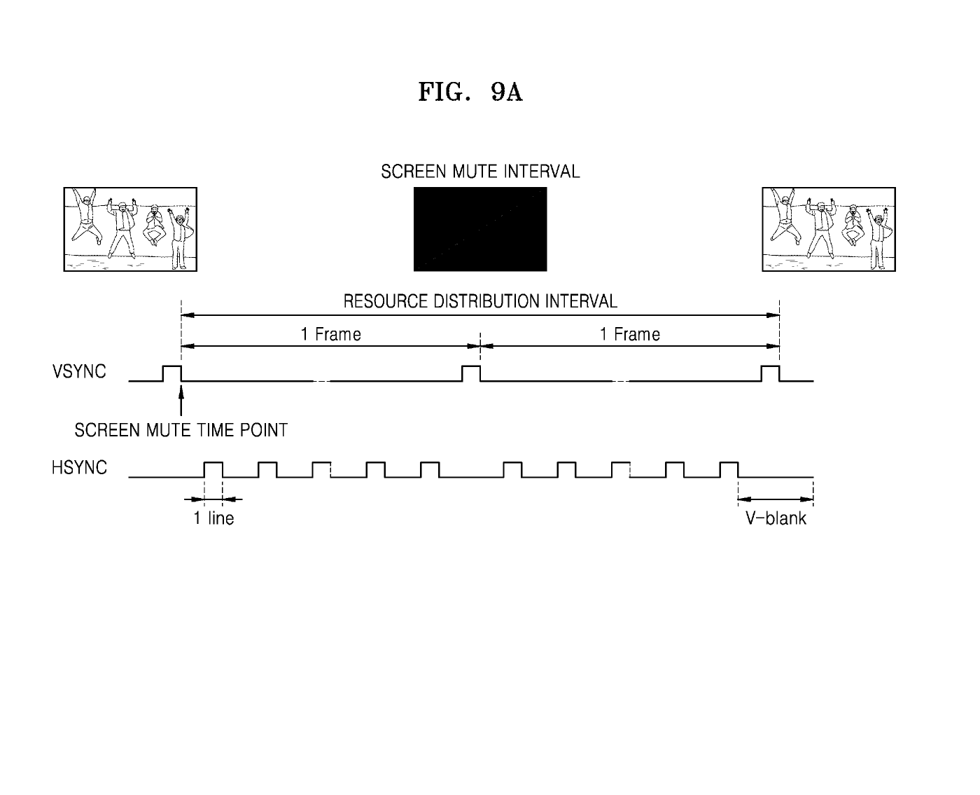

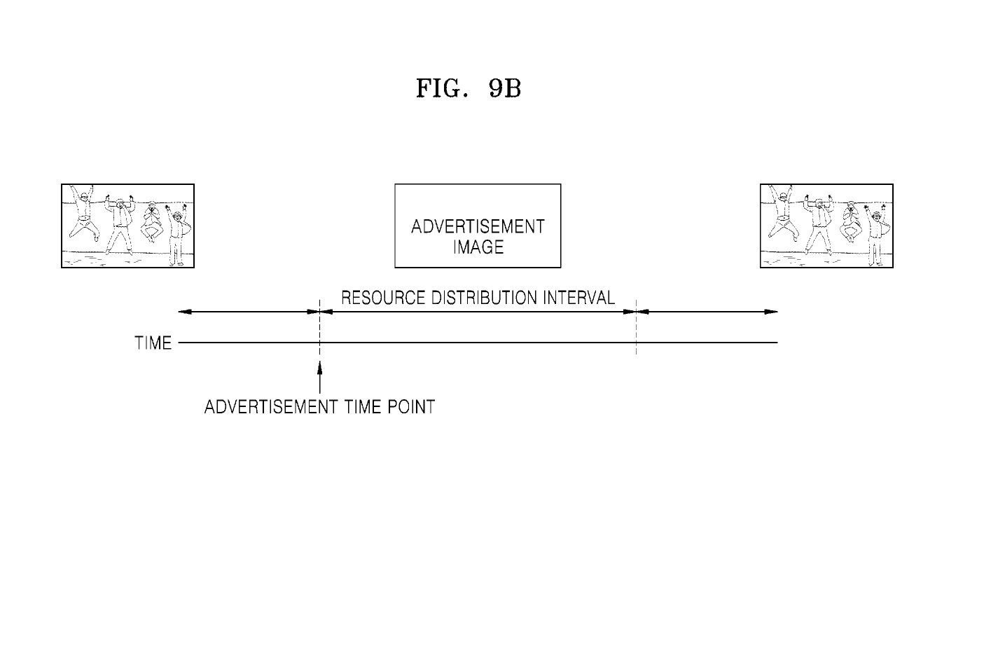

In an embodiment of the disclosure, the image processing apparatus 100 may perform the image processing preparation operation only during a determined resource distribution interval (see, e.g., FIGS. 8, 9A, and 9B). For example, it is difficult for the image processing apparatus 100 to change a neural network model or change a resource distribution proportion of the AI-dedicated processor while outputting an image on a screen. This may be due to characteristics of the AI-dedicated processor. In the disclosure, the image processing apparatus 100 is able to prepare for the image processing using the pre-stored quality statistic data 30 and model parameter dataset 40, and thus may quickly and accurately prepare for the image processing within a determined limited time (the determined resource distribution interval).

In the disclosure, a combination of neural network models pre-determined for image processing may be referred to as a "model set". One model set may include one or more models, for example, a single model or a combined plurality of models. The quality statistic data 30 of the image processing apparatus 100 according to an embodiment of the disclosure may store types of models corresponding to different qualities of images, and information about a plurality of model sets in which resource distribution proportions of models are determined, wherein the types of models and the information about the plurality of model sets are mapped to qualities of images. For example, information indicating that the model A and the model B are required and the resource distribution proportion of the model A and model B are 40%:60% may be pre-stored in the quality statistic data 30, in response to the quality of the input image 10. The image processing apparatus 100 may determine a model set corresponding to the quality of the input image 10, based on the quality statistic data 30 corresponding to the input source of the input image 10.

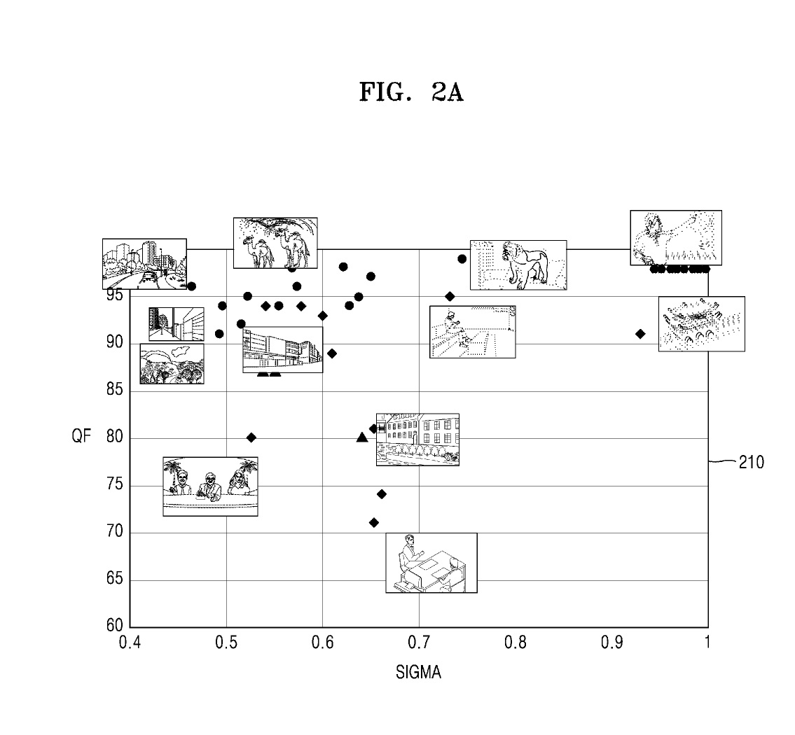

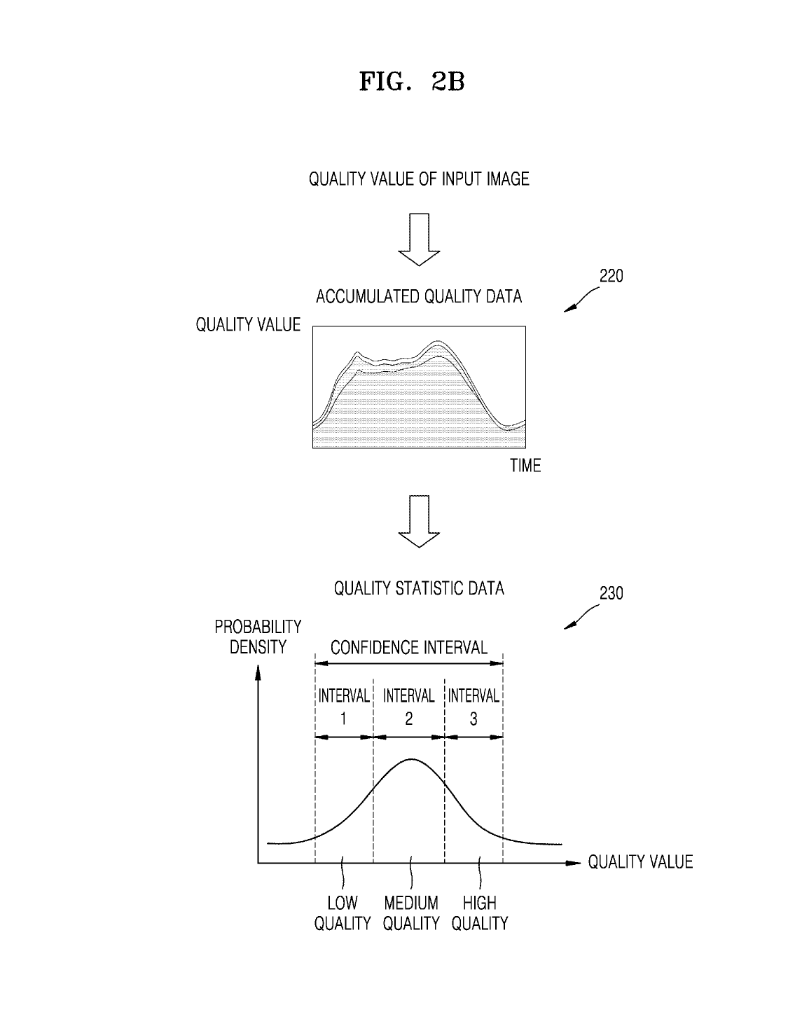

Hereinafter, an example operation of collecting quality statistic data from quality information of an input image will be described in greater detail with reference to FIGS. 2A and 2B.

FIG. 2A is a graph illustrating example quality information of various images, according to various embodiments.

FIG. 2A is a graph showing, on a quality plane, results of analyzing qualities of various images, wherein the results of analyzing the qualities of images using a quality analyzer are shown on a 2-dimensional graph. The quality analyzer may analyze or evaluate image quality or quality of an input image. The quality analyzer may evaluate or determine at least one of compression deterioration of the input image, a compression degree of the input image, a blur degree, a noise degree, or a resolution of the input image. The quality analyzer may analyze or evaluate the image quality of the input image using a neural network trained to analyze or evaluate quality of the input image. For example, the neural network may include a neural network trained to evaluate quality of an image or a video using an image quality assessment (IQA) technology or a video quality assessment (VQA) technology. Alternatively, the quality analyzer may be an algorithm for analyzing or evaluating the image quality of the input image.

Referring to FIG. 2A, in a graph 210, a horizontal axis indicates a kernel sigma value and a vertical axis indicates compression quality (quality factor (QF)). The kernel sigma value is a value indicating a blur quality of an image, wherein a blur degree is high when the kernel sigma value is high and the blur degree is low when the kernel sigma value is low. The QF indicates deterioration caused by compression, wherein the deterioration caused by compression is severe when a QF value is low and the deterioration caused by compression is less when the QF value is high.

However, this is simply an example and the image processing apparatus 100 may analyze the input image to further obtain another quality element in addition to kernel sigma and QF of each input image. For example, the image processing apparatus 100 may analyze the input image and further obtain quality elements such as a noise degree, a detail degree, colorfulness, a resolution, and sharpness of the input image.

In an embodiment of the disclosure, the image processing apparatus 100 may represent a quality value of an image as a k-th vector value (Qk) indicating k quality elements. For example, when the quality elements obtained by the image processing apparatus 100 are kernel sigma, QF, and noise degree, the quality value of the input image may be represented as a vector value indicating the three quality elements of kernel sigma, QF, and noise degree. In this case, the graph 210 may be expressed as a three-dimensional graph representing three axes of kernel sigma, QF, and noise degree.

In an embodiment of the disclosure, the image processing apparatus 100 may obtain quality statistic data as shown in FIG. 2B using the k-th vector value (Qk) indicating k quality elements (k is a natural number).

FIG. 2B is a diagram illustrating an example operation of obtaining quality statistic data from accumulated quality data of an image, according to various embodiments. FIG. 2B illustrates a graph 220 of accumulated quality data in which quality values of images received through one input source are accumulated according to time. In the graph 220, an x axis indicates time and a y axis indicates a quality value.

FIG. 2B illustrates a probability density function (PDF) 230 corresponding to quality statistic data obtained based on the accumulated quality data. The PDF 230 may represent an occurrence probability according to a quality value of an image. An x axis of the PDF 230 indicates a quality value and a y axis thereof indicates probability density (e.g., a possibility that a specific value may occur). In the PDF 230, when a value of the probability density (y axis) is high with respect to a specific quality value (x axis), the corresponding quality value may have been accumulated with a high frequency. In other words, an image of the corresponding quality value may have been viewed frequently. In the PDF 230, when a value of the probability density (y axis) is low with respect to a specific quality value (x axis), the corresponding quality value may have been accumulated with a low frequency. In other words, an image of the corresponding quality value may have been viewed less.

The image processing apparatus 100 may store accumulated quality data obtained by accumulating changes in a vector value (Qk) according to time. The accumulated quality data may be raw data. The image processing apparatus 100 may continuously sample the vector value (Qk) at specific time cycles. The image processing apparatus 100 may analyze frequency or distribution of quality values based on sampled data to obtain statistic data about quality (quality statistic data). In the disclosure, the PDF 230 representing a quality distribution of an image in a Gaussian distribution is illustrated as an example of the quality statistic data, but the quality statistic data is not limited thereto.

A confidence interval of the PDF 230 indicates a range of quality values (values on the x axis) expected to be included in a specific confidence level (e.g., 95%). The confidence level indicates a probability that a true value (e.g., an actual quality value in the accumulated quality data (see the graph 220 of FIG. 2B) may be included in a corresponding confidence interval, and may be set as 95%, 99%, or the like. For example, at a confidence level of 95%, when a lower bound quality value of a confidence interval is Q1 and an upper bound quality value thereof is Q2, a probability that a quality value between Q1 and Q2 may be included in the confidence interval may be 95%. For example, when a confidence level of the PDF 230 is high, an image of a corresponding input source may be a frequently viewed image. For example, the PDF 230 may be used to determine an occurrence probability of an input image according to a quality value, and determine a quality value of a frequently viewed image.

In an embodiment of the disclosure, quality values included in the confidence interval of the PDF 230 may be divided into a plurality of quality intervals (e.g., an interval 1, an interval 2, and an interval 3). The quality interval may be a lower interval in the confidence interval. For example, the plurality of quality intervals may include the interval 1 near a lower bound of the confidence interval, the interval 2 in the middle of the confidence interval, and the interval 3 near an upper bound of the confidence interval. The interval 1 may correspond to a low quality interval, the interval 2 may correspond to a medium quality interval, and the interval 3 may correspond to a high quality interval.

In an embodiment of the disclosure, the image processing apparatus 100 is able to distinguish quality of an input image using the quality interval of the quality statistic data, and thus, may reduce variability of an image according to quality. The quality interval of the quality statistic data has been described as a criterion for distinguishing the quality of the input image, but the criterion is not limited thereto. For convenience of description, it has been described that there are three quality intervals, but the number of the quality intervals is not limited thereto and may be less or more. It has been described that the quality intervals are included in the confidence interval, but locations of the quality intervals are not limited thereto, and the quality intervals may be located outside the confidence interval.

In an embodiment of the disclosure, the image processing apparatus 100 may update the quality statistic data periodically or aperiodically. For example, an aperiodic update may indicate that an update occurs only when a specific event occurs. The image processing apparatus 100 may periodically or aperiodically analyze the accumulated quality data of the input image according to time and store the quality statistic data.

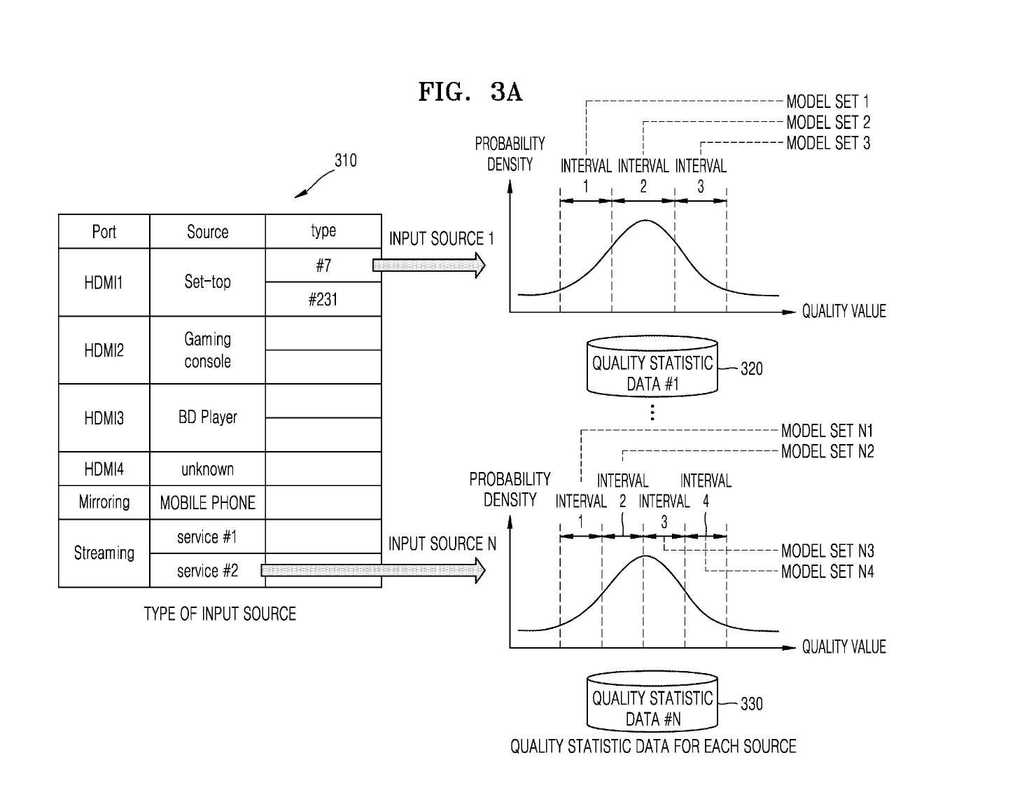

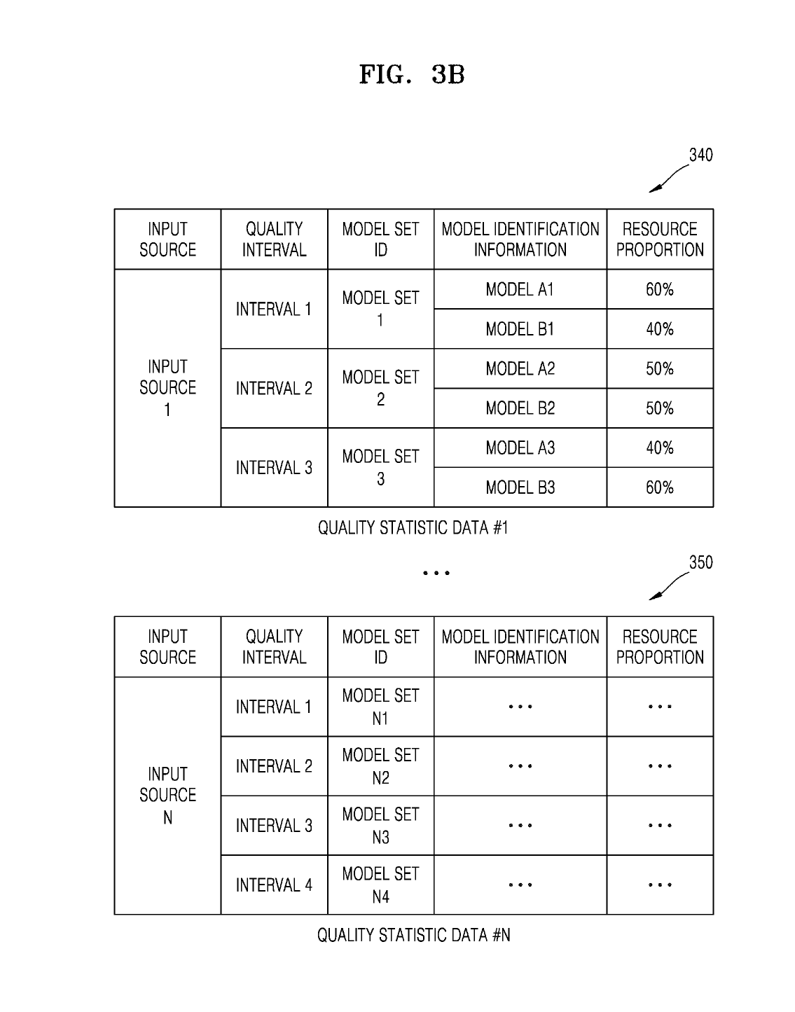

The image processing apparatus 100 according to an embodiment of the disclosure may collect the quality statistic data of the input image for each input source. A model set may be matched to each quality interval in the quality statistic data for each input source. The image processing apparatus 100 may pre-map model set information to the quality statistic data for each quality interval and store the same. This will be described below with reference to FIGS. 3A and 3B.

FIG. 3A includes a diagram and graphs illustrating example quality statistic data for each input source and a model set mapped to each quality interval in the quality statistic data, according to various embodiments.

FIG. 3A illustrates a table 310 representing types of input sources, and quality statistic data (e.g., quality statistic data #1320 and quality statistic data #N 330) for each input source. The types of input sources are not limited by the table 310. The quality statistic data (e.g., the quality statistic data #1320 and the quality statistic data #N 330) for each input source is illustrated as being represented as a probability density function. FIG. 3A illustrates the quality statistic data #1320 corresponding to quality of an image provided by a channel 7 (#7) (here, an input source 1) of a set-top box connected via HDMI, and the quality statistic data #N 330 corresponding to quality of an image provided by a streaming server (service #2) (here, an input source N) connected via streaming.

In an embodiment of the disclosure, quality of an image may be collected separately for each input source. Input sources may be classified by a device physically connected to the image processing apparatus 100 or by a wireless connection type of a device connected to the image processing apparatus 100. For example, the input sources may include a set-top box that provides broadcast content (e.g., IPTV service) by being connected via an input/output unit such as HDMI, a gaming console device (e.g., Xbox) that provides game content, a Blu-ray disc player (BD player), a mobile phone that provides content in a mirroring manner via short-range wireless communication, or a streaming server that provides streaming content in a streaming manner via wireless communication such as Wi-Fi or WLAN. For example, quality of an image included in broadcast content provided by a set-top box (or IPTV service provider) connected to HDMI1, quality of an image included in game content provided by a gaming console device connected to HDMI2, quality of an image included in content provided by a BD player connected to HDMI3, quality of an image provided by a mobile phone via mirroring, or quality of an image provided by a streaming server via streaming may be accumulated separately.

In an embodiment of the disclosure, quality of an image may be collected separately for each channel of broadcast content. For example, quality of an image provided by the channel 7 (#7) of a set-top box connected via HDMI1 may be accumulated separately from quality of an image provided by a channel 231 (#231).

In an embodiment of the disclosure, quality of an image may be collected separately for each content even for a same input source. For example, in a gaming console device, input quality may be stored for each game content. The game content may indicate a type of game software. For example, quality of an image provided by first game content (Game #1) may be accumulated separately from quality of an image provided by second game content (Game #2). For example, quality of an image may be accumulated for each of streaming servers (service #1 and service #2).

However, the disclosure is not limited thereto, and in an embodiment of the disclosure, an input source may further include a cable broadcast receiver or a satellite broadcast receiver, which provides broadcast content by being connected to an input/output unit such as HDMI. In addition, input quality may be stored separately for each type of content.

In an embodiment of the disclosure, the image processing apparatus 100 may accumulate quality of an input image for each input source, for each channel of broadcast content, or for each content, and collect quality statistic data for each input source, for each channel of broadcast content, or for each content. As described with reference to FIG. 2B, the image processing apparatus 100 may generate quality statistic data for each input source by sampling a quality value (raw data) of an image accumulated according to time.

In an embodiment of the disclosure, the image processing apparatus 100 may use extended display identification data (EDID) of an external device, an identifier of an external device, or the like to distinguish each of external devices physically connected to an input/output unit (e.g., an input port). The image processing apparatus 100 may determine whether an input source is a set-top box connected to an HDMI1 port, a gaming console device connected to an HDMI2 port, a BD player connected to an HDMI3 port, or an unknown device connected to an HDMI4 port, based on EDID and/or an identifier of an external device connected to an input port. When an external device physically connected to each input port is changed, the image processing apparatus 100 may automatically update corresponding information and collect information about the external device (e.g., EDID and/or an identifier).

In an embodiment of the disclosure, the image processing apparatus 100 may distinguish a wireless connection type. For example, the image processing apparatus 100 may determine whether the wireless connection type corresponds to mirroring or streaming, using a communication protocol used for the wireless connection type or an identifier (e.g., a media access control (MAC) address or serial information) of an external device.

In an embodiment of the disclosure, the image processing apparatus 100 may map, to the quality statistic data, one or more model sets for each input source, and store the same. The image processing apparatus 100 may map, to each of the plurality of quality intervals included in the quality statistic data, at least one model set, and store the same. For example, three model sets (e.g., a model set 1, a model set 2, and a model set 3) may be mapped to the quality statistic data #1320 corresponding to the input source 1 and stored. The three model sets may be sequentially and respectively mapped to an interval 1 (e.g., a low quality interval), an interval 2 (e.g., a medium quality interval), and an interval 3 (e.g., a high quality interval) and stored. For example, four model sets (e.g., a model set N1, a model set N2, a model set N3, and a model set N4) may be mapped to the quality statistic data #N 330 corresponding to the input source N and stored. The four model sets may be sequentially and respectively mapped to interval 1 to interval 4 and stored. This will be described in further detail with reference to FIG. 3B.

FIG. 3B is a diagram illustrating example lookup tables of quality statistic data for each input source, according to various embodiments. Referring to FIG. 3B, quality statistic data in which model set information is mapped for each input source and for each quality interval is stored in the form of lookup tables 340 and 350. The lookup table 340 corresponds to the quality statistic data #1320 of FIG. 3A and the lookup table 350 corresponds to the quality statistic data #N 330 of FIG. 3A.

Quality statistic data according to an embodiment of the disclosure may store model set information. A model set according to an embodiment of the disclosure may include one or more models used to process an image, for example, a single model or a combination of a plurality of models. The lookup tables 340 and 350 are illustrated such that one model set includes a combination of a plurality of models (e.g., a combination of a model A1 and a model B1), but are not limited thereto, and a model set may include a single model (e.g., the model A1).

Information about a plurality of model sets may be mapped to quality statistic data according to an embodiment of the disclosure and stored. The image processing apparatus 100 may map, to the quality statistic data, the information about the plurality of model sets for each input source, and store the same. For example, in the lookup table 340, information about the model set 1, the model set 2, and the model set 3 may be mapped to the quality statistic data #1 corresponding to the input source 1 and stored. For example, in the lookup table 350, information about the model set N1, the model set N2, the model set N3, and the model set N4 may be mapped to the quality statistic data #N corresponding to the input source N and stored.

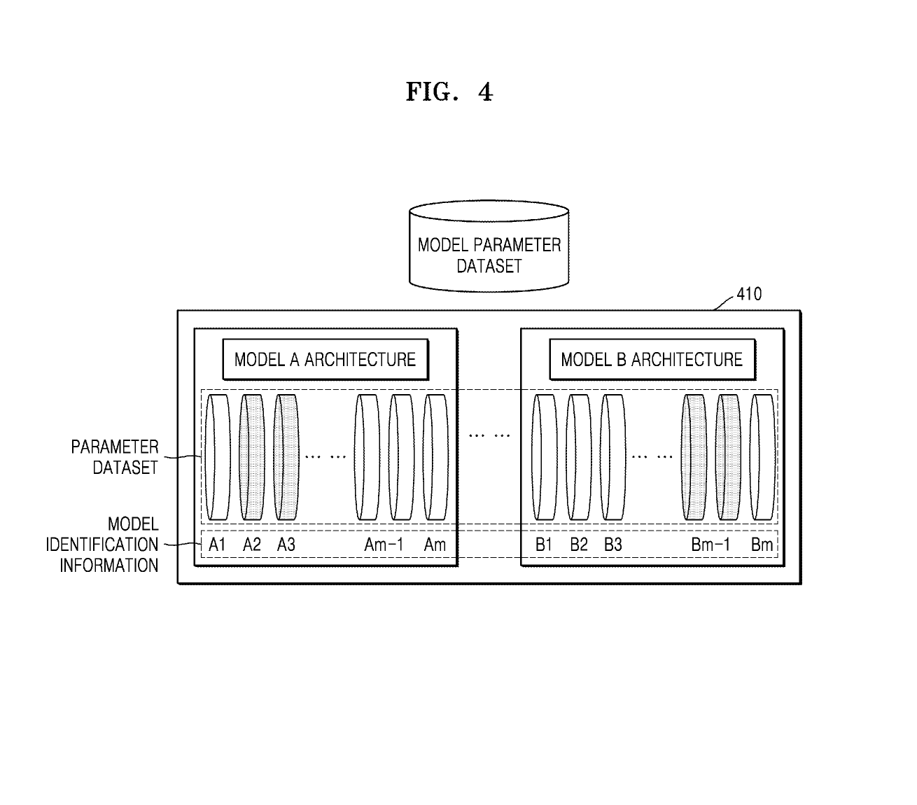

The model set information according to an embodiment of the disclosure may include model set identification information (e.g., identification (ID)), identification information (or combination information) about one or more models included in the model set, and resource distribution proportion information of a second processor for the one or more models. The plurality of model sets according to an embodiment of the disclosure may include different combinations of models. For example, the model set 1 may include the model A1 and the model B1, the model set 2 may include a model A2 and a model B2, and the model set 3 may include a model A3 and a model B3. As will be described in greater detail below with reference to FIG. 4, the model A1, the model A2, and the model A3 may be models having a same image processing function but different parameter datasets. The model B1, the model B2, and the model B3 may be models having a same image processing function but different parameter datasets.

The information about the plurality of model sets for each quality interval may be mapped to the quality statistic data according to an embodiment of the disclosure and stored. The image processing apparatus 100 may map, to the quality statistic data, the information about the plurality of model sets for each quality interval, and store the same. For example, referring to the lookup table 340, the model set 1 may be stored according to the interval 1 of the quality statistic data #1 of the input source 1, the model set 2 may be stored according to the interval 2 thereof, and the model set 3 may be stored according to the interval 3 thereof. Redundant descriptions about the lookup table 350 may not be repeated here.

For example, in the lookup table 340, information about the model set 1 mapped to the interval 1 of the quality statistic data #1 may include identification information about the model A1 and the model B1 (or a combination information of the model A1 and the model B1) and information indicating that a resource distribution proportion of the model A1 and the model B1 is 60%:40%. For example, in the lookup table 340, information about the model set 2 mapped to the interval 2 of the quality statistic data #1 may include identification information about the model A2 and the model B2 and information indicating that a resource distribution proportion of the model A2 and the model B2 is 50%:50%. For example, in the lookup table 340, information about the model set 3 mapped to the interval 3 of the quality statistic data #1 may include identification information about the model A3 and the model B3 and information indicating that a resource distribution proportion of the model A3 and the model B3 is 40%:60%. Descriptions about the model set N1, the model set N2, the model set N3, and the model set N4, which are mapped to the quality statistic data #N, illustrated in the lookup table 350 are the same as those described above, and thus may not be repeated here.

It is illustrated that each of model sets is mapped for each interval of quality statistic data, but the disclosure is not limited thereto, and the model sets may be distinguished and mapped using a different criterion in the quality statistic data. The image processing apparatus 100 according to an embodiment of the disclosure may identify quality statistic data corresponding to an input source of an input image from among a plurality of pieces of quality statistic data pre-stored for each input source, and identify a quality interval of the quality statistic data, corresponding to a quality value of the input image. The image processing apparatus 100 may identify a model set mapped to the identified quality interval to obtain identification information about one or more models corresponding to the input image and resource distribution proportion information of the second processor for the one or more models.

FIG. 4 is a diagram illustrating an example storage 410 in which parameter datasets for a plurality of models are pre-stored, according to various embodiments. The storage 410 may also be referred to as a model parameter dataset storage.

In an embodiment of the disclosure, the storage 410 in which the parameter datasets for the plurality of models is stored may include a plurality of models (e.g., a model A and a model B) having different image processing functions (e.g., super-resolution (SR) and motion estimation (ME)). The storage 410 may include a plurality of models (e.g., a model A1 and a model A2 to a model Am) having a same image processing function but different resource proportions (required resource amounts). For example, the model A1, the model A2, and the model A3 may be models performing a same image processing function (e.g., SR). The model A1, the model A2, and the model A3 may have a same model architecture but different parameter datasets and different required resource amounts. For example, the model A2 may be a neural network that requires less resources than the model A1, e.g., a neural network lighter than the model A1. For example, the model B1, the model B2, and the model B3 may be models performing a same image processing function (e.g., ME). The model B1, the model B2, and the model B3 may have a same model architecture but different parameter datasets and different required resource amounts.

In the disclosure, model architectures being the same may indicate that layer configurations of models are the same, the numbers of layers are the same, and connection manners of layers are the same. For example, when two models use a same CNN structure and have a same filter size (or kernel size) and a same stride, it may be said that "architectures are the same".

In the disclosure, model parameter datasets being different may indicate that weights and bias values obtained by models through learning are different. Even when models have a same architecture, the models may have different parameter datasets in case that the models are trained with different datasets or use different initialization methods. The models may have different numbers or types of filters (e.g., a Gaussian filter or a mean filter), and as a result, the models may have different methods of processing input data. When parameter datasets of the models are different, amounts of neural processing unit (NPU) resources required when the models are executed may be different.

In an embodiment of the disclosure, a parameter dataset of a model may include model architecture information (e.g., the number of layers in the model and the number of channels per layer), weight data used in a channel of each layer, and the like.

In an embodiment of the disclosure, the image processing apparatus 100 may obtain, based on the model set information, storage location information about the parameter dataset of the model. The storage location information about the parameter dataset of the model may indicate a storage location where the parameter dataset of the model is stored from among the pre-stored parameter datasets of the plurality of models. The parameter dataset of the model may be loaded onto the second processor through the storage location information. The storage location information of the model may be represented in the form of embedding data, but is not limited thereto. The identification information and the parameter dataset of each model may be stored as a pair in the storage 410 in which the parameter datasets for the plurality of models are stored. Accordingly, the image processing apparatus 100 may obtain, from among the parameter datasets for the plurality of models, the storage location information of the parameter dataset stored by being mapped to the identification information of models required for image processing. The image processing apparatus 100 may load the parameter dataset of the model onto the second processor, based on the storage location information.

Referring back to FIG. 3B, in an embodiment of the disclosure, different model sets stored for a same input source are the same in that the model sets include a combination of models having a same image processing function, and are different from each other in that parameter datasets and resource proportions (required resource amounts) of models included in the model sets are different. For example, the model set 1, the model set 2, and the model set 3 mapped to the input source 1 may include a combination of an image processing function (e.g., SR) of the model A and an image processing function (e.g., CE) of the model B. For example, the resource distribution proportion of the model A1 and the model B1 included in the model set 1 may be 60%:40%. The resource distribution proportion of the model A2 and the model B2 included in the model set 2 may be 50%:50%. The resource distribution proportion of the model A3 and the model B3 included in the model set 3 may be 40%:60%.

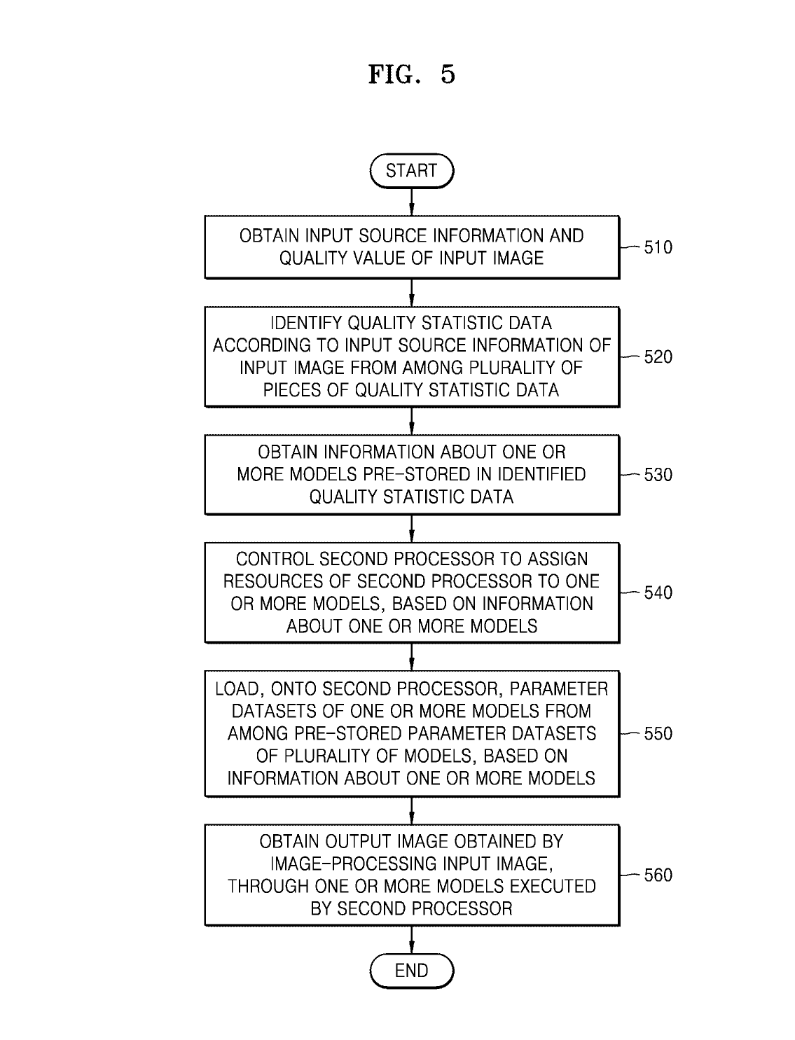

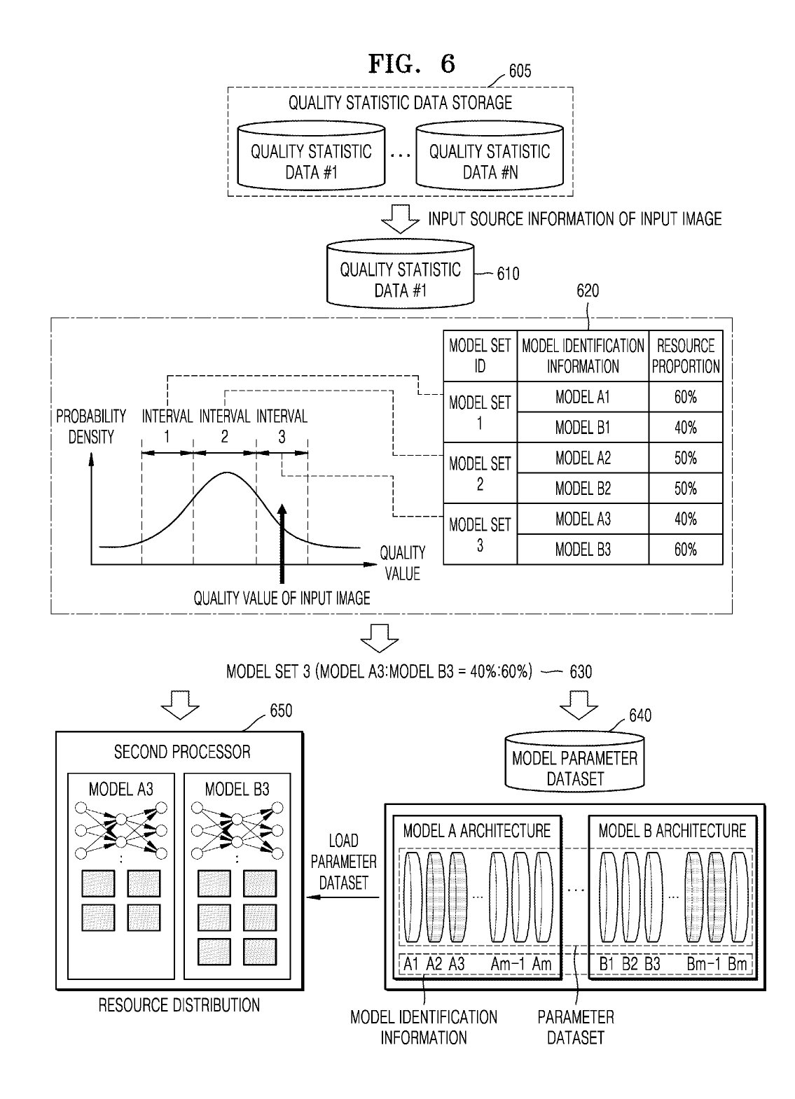

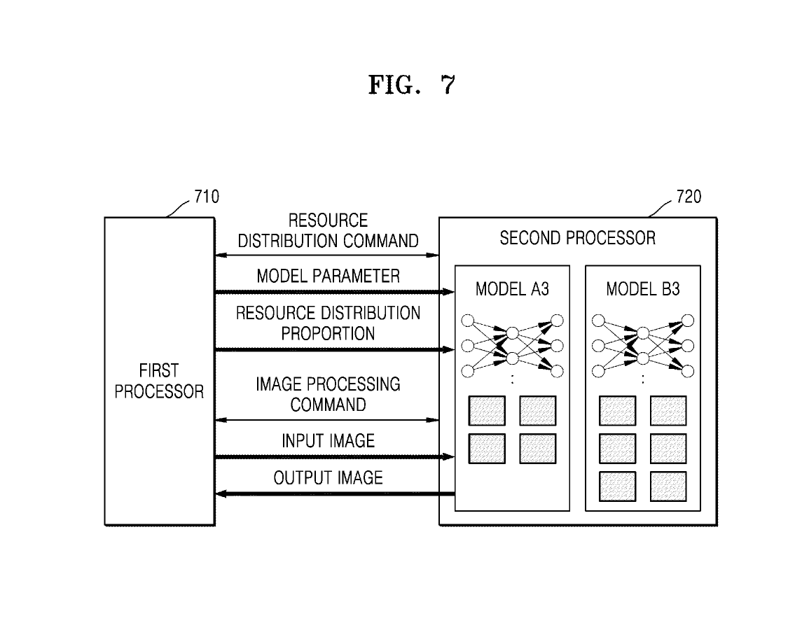

FIG. 5 is a flowchart illustrating an example operation method of an image processing apparatus, according to various embodiments. FIG. 6 is a diagram illustrating example operations in which an image processing apparatus distributes resources of a second processor according to a quality value of an input image, according to various embodiments. FIG. 7 is a diagram illustrating example image processing operations between a first processor and a second processor, according to various embodiments. A method of operating the image processing apparatus 100, according to an embodiment of the disclosure, may be performed by at least one first processor and memory.

Referring to FIG. 5, in operation 510, the image processing apparatus 100 may obtain input source information and quality value of an input image.

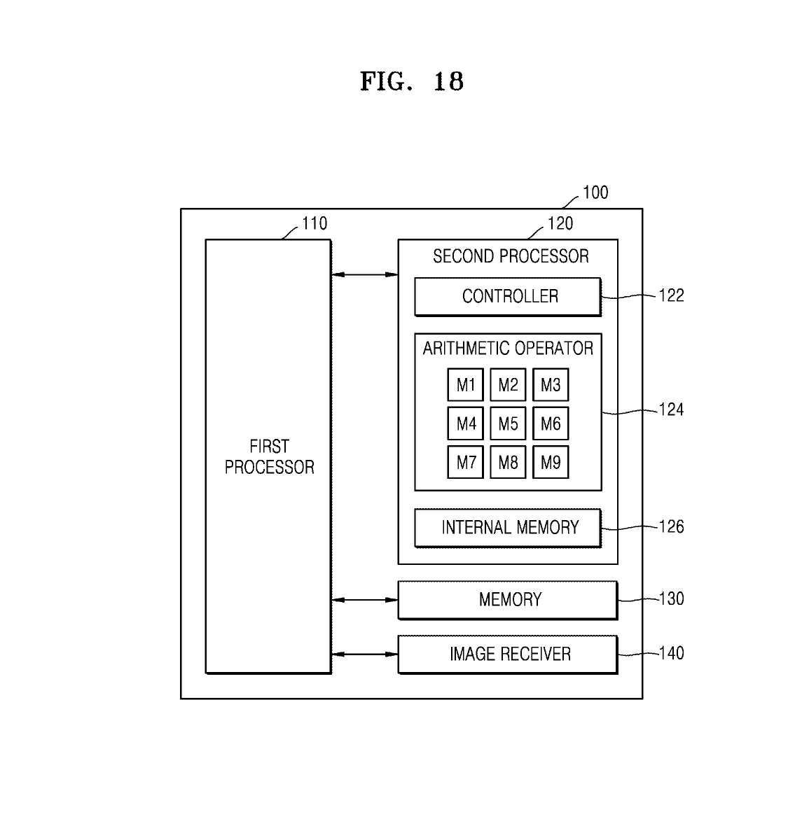

The image processing apparatus 100 according to an embodiment of the disclosure may process the input source information of the input image. The input source information may include information about an interface for connecting the image processing apparatus 100 to an external device wirelessly or via wires. For example, the input source information may include input port information (e.g., HDMI or USB), wireless connection type information (e.g., mirroring or streaming), and the like. Input sources may be classified by a device physically connected to the image processing apparatus 100 or by a wireless connection type of a device connected to the image processing apparatus 100. For example, the input source information may include information for identifying a type of an image receiver 140 of FIG. 18 included in the image processing apparatus 100.

The image processing apparatus 100 may be physically connected to the external device (e.g., a set-top box, a gaming console device, a BD player, or an unknown device) through an input port. The image processing apparatus 100 may be wirelessly connected to the external device (e.g., a mobile phone or a streaming server) through a communication module. The input source information may be used to identify quality statistic data corresponding to the input source from among a plurality of pieces of quality statistic data stored for each input source.

For example, the input source information may include the input port information. The image processing apparatus 100 may receive EDID of an external device physically connected to an input port, an identifier of the external device, and the like. The input port information may include the EDID of the external device, the identifier of the external device, and the like. The EDID may include information about a resolution, a scan rate, and a manufacturer of the external device. The image processing apparatus 100 may determine to which port from among HDMI1 to HDMI4 the image processing apparatus 100 is connected, based on the EDID and/or the identifier of the external device connected to the input port. For example, a set-top box providing IPTV service may be connected to HDMI1. A gaming console device providing game content may be connected to HDMI2. A BD player may be connected to HDMI3. An unknown device may be connected to HDMI4. However, the disclosure is not limited thereto.

For example, the input source information may include the wireless connection type information. The wireless connection type information may include information about a communication protocol used for a wireless connection type or an identifier (e.g., an MAC address or serial information) of an external device. The image processing apparatus 100 may determine whether the wireless connection type corresponds to mirroring or streaming, based on the wireless connection type information. For example, when a wireless communication protocol indicates Wi-Fi direct and serial information indicates a mobile phone, an image may be received via mirroring. For example, when a wireless communication protocol indicates Wi-Fi and an MAC address indicates a streaming server, an image may be received via streaming.

The image processing apparatus 100 according to an embodiment of the disclosure may obtain the quality value of the input image. As described with reference to FIG. 2A, the image processing apparatus 100 may analyze or evaluate an image quality or quality of the input image using a quality analyzer. The quality analyzer may evaluate or determine at least one of compression deterioration of the input image, a compression degree of the input image, a blur degree, a noise degree, the resolution of the image, a detail degree, colorfulness, or sharpness. The quality analyzer may include a neural network trained to evaluate quality of an image or a video using an image quality assessment (IQA) technology or a video quality assessment (VQA) technology. Alternatively, the quality analyzer may be an algorithm for analyzing or evaluating the image quality of the input image. The quality value is not restricted to a specific value and may be replaced by a quality degree, a quality level, or the like. In an embodiment of the disclosure, the quality value of the input image may be used to determine to which quality interval (an x axis interval) the quality of the input image corresponds, in quality statistic data corresponding to a specific input source. The quality statistic data may be divided into a plurality of quality intervals.

The image processing apparatus 100 according to an embodiment of the disclosure may store, in the memory, the quality value of the input image obtained through the quality analyzer. The quality values of the input image stored in the memory may be used to generate the quality statistic data. The image processing apparatus 100 may periodically or aperiodically update the quality value of the input image to the quality statistic data. The updating of the quality statistic data may be performed separately from an image processing operation for the input image.

The image processing apparatus 100 according to an embodiment of the disclosure may identify whether the input source is an input source that has been previously used by a user, based on the input source information. For example, the image processing apparatus 100 may identify whether a channel has been viewed by the user, based on channel information. The image processing apparatus 100 may identify whether a device has been previously connected, based on the input source information (the EDID of the external device and/or the identifier of the external device). The image processing apparatus 100 may identify whether there is a use history by the user, based on both the channel information and the input source information. When there is the use history, the image processing apparatus 100 may operate according to operation 520. On the other hand, when there is no use history, the image processing apparatus 100 may identify that the connected input source is a new device and newly generate quality statistic data based on input source information of the new device.

In operation 520, the image processing apparatus 100 may identify quality statistic data corresponding to the input source information of the input image from among a plurality of pieces of quality statistic data.

In operation 530, the image processing apparatus 100 may obtain information about one or more models, pre-stored in the identified quality statistic data. In the disclosure, one or more models may be referred to as a "model set" and information about the one or more models may be referred to as "model set information".

In an embodiment of the disclosure, the input source information of the input image may be used to identify the quality statistic data and the quality value of the input image may be used to identify the quality interval in the quality statistic data and determine a model set. The model set may include one or more models, for example, a single model or a combined plurality of models.

In an embodiment of the disclosure, the quality statistic data may be stored for each input source. The image processing apparatus 100 may pre-store the plurality of pieces of quality statistic data for each input source. The plurality of pieces of quality statistic data may be stored in a quality statistic data storage 605 of FIG. 6. The image processing apparatus 100 may accumulate the quality value of the input image for each input source. The image processing apparatus 100 may obtain the quality statistic data for each input source, based on accumulated quality data for each input source. The quality statistic data may be represented in the form of a probability density function, but is not limited thereto. This has been described above with reference to FIGS. 2A and 2B.

In an embodiment of the disclosure, the quality statistic data for each input source may include at least one of quality statistic data for each set-top box providing broadcast content (e.g., an IPTV service), for each gaming console device (e.g., Xbox) providing game content, for each BD player, for each mobile phone providing content via mirroring, or for each streaming server providing streaming content. However, a type of the input source is not limited thereto.

In an embodiment of the disclosure, the quality statistic data may be stored for each channel of broadcast content or for each content. The image processing apparatus 100 may pre-store the plurality of pieces of quality statistic data for each channel of the broadcast content or for each content. For the broadcast content, the quality statistic data may be stored for each channel (e.g., a sports channel, a movie channel, or a news channel). For the streaming content, the quality statistic data may be stored for each streaming content. For the game content, the quality statistic data may be stored for each game content. However, the disclosure is not limited thereto. This has been described above with reference to FIG. 3A.

In an embodiment of the disclosure, the quality statistic data may be mapped to the model set information for each input source and for each quality interval, and stored. The image processing apparatus 100 may map, to the quality statistic data, the one or more models for each input source, and store the same. The image processing apparatus 100 may map, to each of the plurality of quality intervals included in the quality statistic data, at least one model set, and store the same. For example, three model sets (e.g., a model set 1, a model set 2, and a model set 3) may be mapped to quality statistic data #1 610 of FIG. 6 corresponding to an input source 1 and stored. The three model sets may be sequentially and respectively mapped to an interval 1 (e.g., a low quality interval), an interval 2 (e.g., a medium quality interval), and an interval 3 (e.g., a high quality interval) and stored. This has been described above with reference to FIGS. 3A and 3B.

The model set information according to an embodiment of the disclosure may include model set identification information (e.g., identification (ID)), identification information (or combination information) about one or more models included in the model set, and resource distribution proportion information of a second processor for the one or more models.

The model set according to an embodiment of the disclosure may include a plurality of model sets including different combinations of models. Each of the plurality of model sets mapped to same quality statistic data may include models combined to have a same image processing function but different resource distribution proportions.

Referring to FIG. 6, the image processing apparatus 100 according to an embodiment of the disclosure may identify the quality statistic data #1610 of FIG. 6 corresponding to an input source of an input image from among a plurality of pieces of quality statistic data pre-stored in the quality statistic data storage 605 of FIG. 6 for each input source. For example, when the input source of the input image is a set-top box connected through HDMI1, the image processing apparatus 100 may identify the quality statistic data #1 610 of FIG. 6 in which quality values of images provided by the set-top box are accumulated and distributed. The image processing apparatus 100 may identify that a quality interval of the quality statistic data #1610 of FIG. 6 to which the quality value of the input image belongs is an interval 3. For example, when it is determined that the quality value of the input image belongs to the interval 3, the image processing apparatus 100 may obtain information 630 of FIG. 6 about a model set 3 mapped to the interval 3. For example, the information 630 of FIG. 6 about the model set 3 may include identification information of a model A3 and a model B3 (or combination information of the model A3 and the model B3) and information indicating that a resource distribution proportion of the model A3 and the model B3 is 40%:60%. The quality statistic data #1610 of FIG. 6 corresponds to the quality statistic data #1320 of FIG. 3A and the lookup table 340 of FIG. 3B.

In operation 540, the image processing apparatus 100 may control the second processor to assign resources of the second processor to the one or more models, based on the information about the one or more models.

In an embodiment of the disclosure, the image processing apparatus 100 may control the second processor to prepare for image processing, based on the model set information. The second processor may prepare for the image processing on the input image, according to control by the image processing apparatus 100.

In an embodiment of the disclosure, the image processing apparatus 100 may control the second processor to assign the resources of the second processor to the one or more models, based on the identification information (or combination information) about the one or more models included in the model set and resource distribution proportion information of the second processor for the one or more models.

In an embodiment of the disclosure, the image processing apparatus 100 may transmit a command to the second processor to distribute the resources to the one or more models according to a resource distribution proportion.

In operation 550, the image processing apparatus 100 may load, onto the second processor, parameter datasets of the one or more models from among pre-stored parameter datasets of a plurality of models, based on the information about the one or more models.

In an embodiment of the disclosure, the parameter datasets of the plurality of models may be pre-stored in a storage 640 of FIG. 6. The image processing apparatus 100 may pre-store the parameter datasets of the plurality of models in the storage 640 of FIG. 6. The identification information and the parameter dataset of each model may be stored as a pair in the storage 640 of FIG. 6 in which the parameter datasets for the plurality of models are stored. The storage 640 of FIG. 6 may also be referred to as a model parameter dataset storage.

In an embodiment of the disclosure, the image processing apparatus 100 may obtain, based on the model set information, storage location information about the parameter dataset of the model. The storage location information about the parameter dataset of the model may indicate a storage location where the parameter dataset of the model is stored from among the pre-stored parameter datasets of the plurality of models. The parameter dataset of the model may be loaded onto the second processor through the storage location information. The image processing apparatus 100 may obtain, from among the parameter datasets for the plurality of models, the storage location information of the parameter dataset stored in the storage 640 of FIG. 6 by being mapped to (or paired with) the identification information of models required for image processing. The storage 640 of FIG. 6 corresponds to the storage 410 of FIG. 4.

In an embodiment of the disclosure, the image processing apparatus 100 may load the parameter dataset of the model onto the second processor, based on the storage location information. The second processor may store, in an internal memory of the second processor, received model parameter dataset information. Alternatively, for example, the image processing apparatus 100 may transmit the storage location information to the second processor. In this case, the second processor may receive the storage location information of the parameter dataset of the model, directly access the storage 640 of FIG. 6 of the image processing apparatus 100, and load the parameter dataset of the model stored in the storage location information.

For example, the image processing apparatus 100 may not use the storage location information but may immediately load, onto the second processor, the parameter dataset mapped to and stored with the identification information of the model.

The image processing apparatus 100 according to an embodiment of the disclosure may, during a determined resource distribution interval, assign the resources of the second processor to the one or more models and at the same time, load the parameter datasets of the one or more models onto the second processor. Descriptions about the determined resource distribution interval will be described in greater detail below with reference to FIGS. 8, 9A, and 9B.

With respect to each model (e.g., the model A3 or the model B3) illustrated in FIGS. 6 and 7, the parameter dataset of the model may have been loaded onto a memory of a second processor 650 of FIG. 6 or 720 of FIG. 7). Each neural network may be loaded by a first processor 710 of FIG. 7 and stored in the second processor 650 of FIG. 6 or 720 of FIG. 7, or may be directly loaded by the second processor 650 of FIG. 6 or 720 of FIG. 7.

Referring to FIG. 7, the image processing apparatus 100 may transmit, to the second processor 720 of FIG. 7 through the first processor 710 of FIG. 7, a command to distribute resources to one or more models according to a resource distribution proportion. The first processor 710 of FIG. 7 may transmit, to the second processor 720 of FIG. 7, a model parameter dataset and resource distribution proportion information. The second processor 720 of FIG. 7 may assign the resources of the second processor 720 of FIG. 7 to the one or more models according to the determined resource distribution proportion, based on the model parameter dataset and the resource distribution proportion information. For example, the second processor 720 of FIG. 7 may distribute 40% of the resources (e.g., four arithmetic operators) to the model A3 and 60% of the resources (e.g., six arithmetic operators) to the model B3, according to a resource distribution command of the first processor 710 of FIG. 7. Operations of the second processor 720 of FIG. 7 are the same as operations of the second processor 650 of FIG. 6.

The image processing apparatus 100 according to an embodiment of the disclosure may quickly prepare for image processing using quality statistic data storing model sets in which a combination of appropriate models and a resource distribution proportion of each model are pre-determined according to quality of an input image. In other words, a combination of appropriate models and a resource distribution proportion of each model for processing quality of an input image may be determined only by selecting a model set determined according to quality of an input image. Accordingly, a time taken to prepare for image processing may be reduced. Thus, the image processing apparatus 100 may quickly prepare for image processing within a determined resource distribution interval, such as a channel change or an input source change.

In operation 560, the image processing apparatus 100 may obtain an output image obtained by image-processing the input image, through the one or more models executed by the second processor.

The image processing apparatus 100 according to an embodiment of the disclosure may quickly perform an image processing preparation operation according to operations 510 to 550 described above.

Referring to FIG. 7, the image processing apparatus 100 may command to perform the image processing on the input image using the one or more models to which the resources have been distributed by the second processor 720 of FIG. 7 through the first processor 710 of FIG. 7. The second processor 720 of FIG. 7 may perform an arithmetic operation on the input image, based on the resources distributed to each model and the received parameter dataset of the model. For example, the second processor 720 of FIG. 7 may perform image processing on the input image by performing the arithmetic operations on the model A3 and model B3 to which the resources are assigned. The second processor 720 of FIG. 7 may generate an output image from the input image through image processing. The arithmetic operations for the one or more models may be performed in parallel. For example, the second processor 720 of FIG. 7 may perform a first arithmetic operation for the model A3 and a second arithmetic operation for the model B3 in parallel. The second processor 720 of FIG. 7 may transmit the output image to the first processor 710 of FIG. 7. However, the disclosure is not limited thereto, and the second processor 720 of FIG. 7 may transmit the output image directly to a display of the image processing apparatus 100.

The image processing apparatus 100 according to an embodiment of the disclosure may quickly perform the image processing on the input image using the models to which the resources have been distributed. Accordingly, a high quality image may be quickly provided to the user.

FIG. 8 is a flowchart illustrating an example method of operating an image processing apparatus, according to various embodiments. FIG. 9A is a diagram illustrating an example resource distribution interval determined according to various embodiments. FIG. 9B is a diagram illustrating an example resource distribution interval determined according to various embodiments.

Referring to FIG. 8, in operation 810, the image processing apparatus 100 may identify whether an interval corresponds to a determined resource distribution interval. When the interval corresponds to the determined resource distribution interval (operation 810 – yes), the image processing apparatus 100 may perform resource distribution according to operations 820, 830, 840, 850, 860, and 870. Operations 820, 830,840, 850, 860, and 870 correspond to operations 510, 520, 530, 540, 550, and 560 of FIG. 5, and thus, details thereof may not be repeated here.

In an embodiment of the disclosure, it is illustrated that operation 810 is performed before operations 820, 830, 840, 850, 860, and 870, but the disclosure is not limited thereto, and operation 810 may be performed after at least one of operation 820, operation 830, operation 840, operation 850, operation 860, or operation 870 is performed.

In an embodiment of the disclosure, the determined resource distribution interval may correspond to an interval when an input image is not output to the image processing apparatus 100. For example, an entry time point of the determined resource distribution interval may include at least one of a screen mute time point or a time point when an advertisement image is output, wherein the screen mute time point includes at least one of an input source change time point, an input channel change time point, or a resolution change time point of the input image. An input image to be viewed by a user may not be output during a screen mute interval or an advertisement interval.

For example, referring to FIG. 9A, the screen mute interval may be an interval where a black screen is output. The screen mute time point may include at least one of the input source change time point, a broadcast content channel change time point, or the resolution change time point of the input image. For example, when an input source of the image processing apparatus 100 is changed, the image processing apparatus 100 may enter the screen mute interval. For example, when the input source of the image processing apparatus 100 is a same set-top box but a broadcast channel is changed, the image processing apparatus 100 may enter the screen mute interval. For example, when a resolution of an input image of the image processing apparatus 100 is changed, the image processing apparatus 100 may enter the screen mute interval. During the screen mute interval, the image processing apparatus 100 may distribute resources of the second processor according to the input image and load a parameter dataset of a model.

For example, referring to FIG. 9B, the advertisement interval may be an interval where an advertisement image is output instead of an image provided by the input source. An advertisement time point may be a time point when the advertisement image is output instead of the input image to be viewed by the user. During the advertisement interval, the image processing apparatus 100 may distribute resources of the second processor according to the input image and load a parameter dataset of a model.

In an embodiment of the disclosure, the image processing apparatus 100 may quickly prepare for image processing corresponding to quality of an input image during the determined resource distribution interval. During at least one of the screen mute interval or the advertisement interval, the image processing apparatus 100 may change architectures and weights of models to be calculated by the second processor, and redistribute resources for the models. The image processing apparatus 100 may redistribute the resources during an interval where an image output by the input source is not output, thereby securing a time for resource redistribution.

For example, a required image processing function varies depending on an input source change, a channel change, or an input image resolution change, and resource distribution proportions of models performing respective image processing functions may also vary. In other words, a model architecture is changed when a model type is changed, and resource distribution proportions between models are changed. Accordingly, a time taken for the second processor to redistribute resources may be at least 2 frame durations. The image processing apparatus 100 may redistribute the resources during the screen mute interval in which the black screen is output throughout two frames.

In an embodiment of the disclosure, the second processor may include a pixel processing NPU. The pixel processing NPU may be a processor configured to perform an arithmetic operation in units of lines of an image. A line may indicate a horizontal arrangement (e.g., a column) of pixels in an image. In other words, the pixel processing NPU may differ from an NPU configured to perform an arithmetic operation in units of frames in that the pixel processing NPU performs an arithmetic operation in units of lines. A frame processing NPU is an NPU with lower arithmetic operation processing capability than the pixel processing NPU. The frame processing NPU may be an NPU used to execute a model that does not require an arithmetic operation for all pixels, for example, an object recognition model. In other words, because the frame processing NPU is in units of frames, the frame processing NPU may operate according to timing of VSYNC. Also, because the frame processing NPU performs an arithmetic operation in units of layers of a model, the frame processing NPU may perform time division arithmetic operation. For example, when an arithmetic operation on an i-th layer of a model A is completed, an arithmetic operation on a j-th layer of a model B may be performed.

However, because the pixel processing NPU performing an arithmetic operation in units of lines operates according to timing of HSYNC, the pixel processing NPU has a low freedom of degree compared to an arithmetic operation in units of frames. In other words, one pixel line needs to be processed within HSYNC of one cycle and before a next line is received. In such a pixel processing NPU, it is difficult to redistribute resources during a vertical blank (V-blank) interval (see FIG. 9A). The V-blank interval indicates a spare interval or a blank interval where there is no image signal after an image signal corresponding to one frame is received and before an image signal of a next frame is received. For example, the frame processing NPU is able to change an architecture of a model required during the V-blank interval and change resource distribution proportions between models, and thus, a resource distribution interval (or a resource distribution time point) is not required to be determined. However, when the pixel processing NPU changes an architecture of a model within a limited time (e.g., the V-blank interval) and distributes resources to the model, a bandwidth of an input/output channel of the NPU may instantaneously increase, and thus, the NPU may not operate normally. Accordingly, the pixel processing NPU may need to secure a sufficient time to redistribute resources. Thus, the image processing apparatus 100 may redistribute resources only during the determined resource distribution interval. Also, the image processing apparatus 100 pairs and stores parameter datasets of a plurality of models with respective identification information of the plurality of models, and thus, the parameter dataset may be quickly loaded during the limited resource distribution interval.

However, the disclosure is not limited thereto, and the image processing apparatus 100 according to an embodiment of the disclosure may redistribute resources during an out-of-box experience (OOBE) stage before the image processing apparatus 100 is used. For example, the OOBE stage may include network setting, input port detection, consumer preferred neural network model selection, and intelligent AI mode configuration. The image processing apparatus 100 may pre-distribute resources in the OOBE stage to provide a high quality image from initial installation of the image processing apparatus 100. The input port detection may be performed through a device EDID.

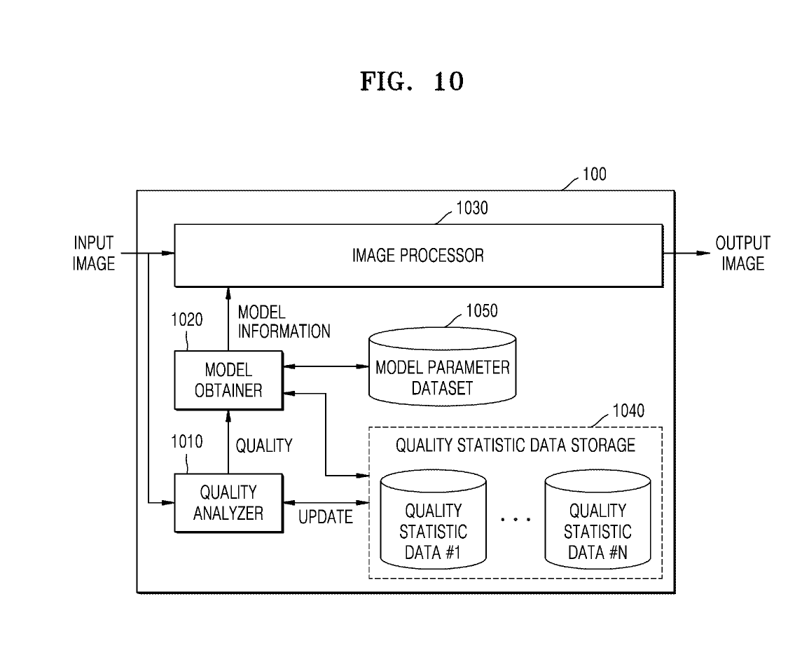

FIG. 10 is a block diagram illustrating an example configuration of an image processing apparatus for performing an image processing operation, according to various embodiments.

Referring to FIG. 10, the image processing apparatus 100 according to an embodiment of the disclosure may include a quality analyzer 1010, a model obtainer 1020, and an image processor 1030. Each of the quality analyzer 1010, the model obtainer 1020, and the image processor 1030 may include software, such as program code, an instruction, an algorithm, or a data structure, which is executed by a first processor 110. The quality analyzer 1010, the model obtainer 1020, and the image processor 1030 may operate according to at least one instruction stored in memory.

The quality analyzer 1010 according to an embodiment of the disclosure may analyze or evaluate image quality or quality of an input image. Image quality of an image may indicate a deterioration degree of the image. The quality analyzer 1010 may evaluate or determine at least one of compression deterioration of the input image, a compression degree of the input image, a blur degree, a noise degree, or a resolution of the input image. The quality analyzer 1010 according to an embodiment of the disclosure may include a quality analyzer described with reference to FIG. 2A. For example, the quality analyzer may include a neural network trained to evaluate quality of an image or a video using an image quality assessment (IQA) technology or a video quality assessment (VQA) technology. Alternatively, the quality analyzer may be an algorithm for analyzing or evaluating the image quality of the input image.

The quality analyzer 1010 according to an embodiment of the disclosure may obtain and store quality statistic data for each input source of an input image. The quality analyzer 1010 may store, in a quality statistic data storage 1040, a plurality of pieces of quality statistic data, for example, quality statistic data #1 to quality statistic data #N, according to a plurality of input sources. The quality analyzer 1010 may periodically or aperiodically analyze accumulated quality data of the input image according to time and store the quality statistic data. This has been described above with reference to FIGS. 3A and 3B. The quality statistic data storage 1040 may correspond to internal memory of the image processing apparatus 100 or an external database.

The quality analyzer 1010 according to an embodiment of the disclosure may transmit quality information to the model obtainer 1020.

The model obtainer 1020 according to an embodiment of the disclosure may obtain, based on the quality information of the input image received from the quality analyzer 1010 and based on the quality statistic data storage 1040, model set information (e.g., combination information of one or more models, identification information of the one or more models, and resource distribution proportion information) corresponding to the quality of the input image. The model obtainer 1020 according to an embodiment of the disclosure may obtain, based on a model parameter dataset storage 1050, storage location information of parameter datasets of models, which are paired with the identification information of the one or more models included in a model set and stored. This has been described above with reference to FIG. 4. The model parameter dataset storage 1050 may correspond to the internal memory of the image processing apparatus 100 or an external database.

The model obtainer 1020 according to an embodiment of the disclosure may transmit, to the image processor 1030, model set information (e.g., the combination information of the one or more models, the identification information of the one or more models, the resource distribution proportion information, and the storage location information of the parameter dataset).

The image processor 1030 according to an embodiment of the disclosure may include various circuitry and load the one or more models onto the second processor and distribute resources, based on the model set information. The image processor 1030 may output an output image by image-processing the input image using the one or more models to which the resources have been distributed. Operations of the image processor 1030 have been described with reference to FIG. 7.

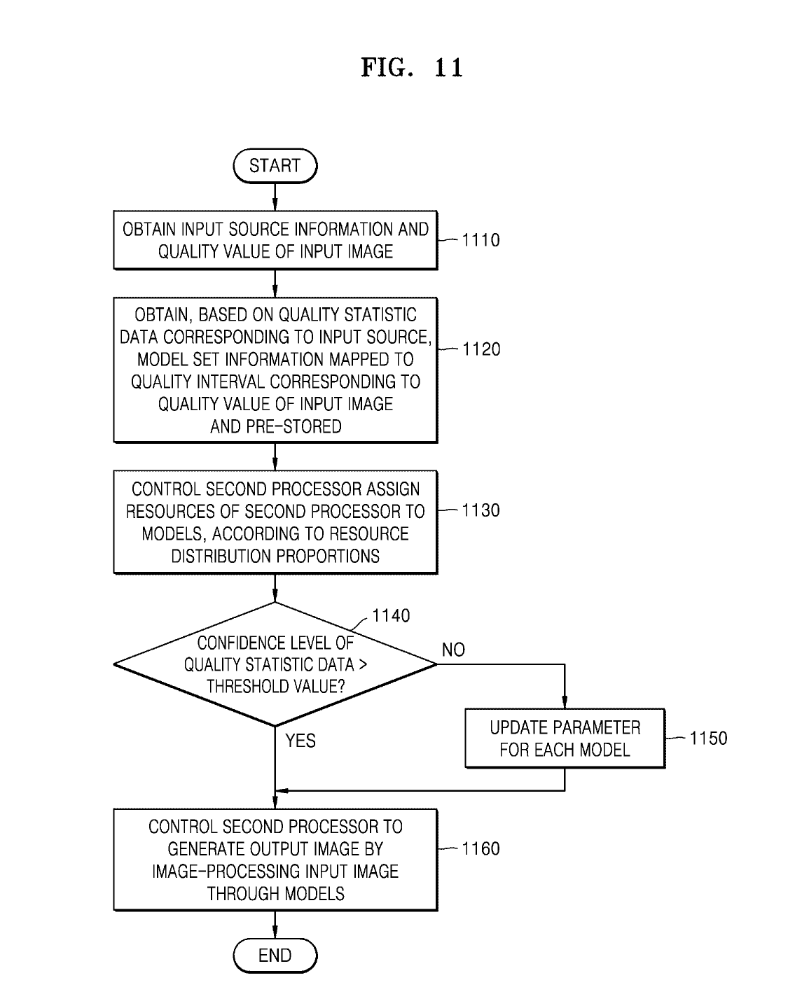

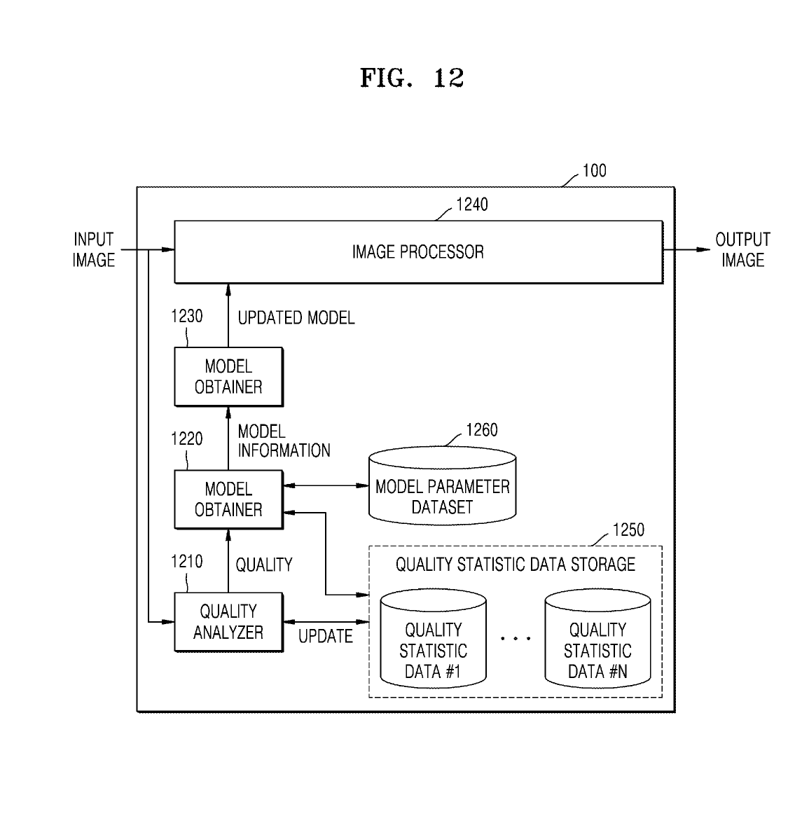

FIG. 11 is a flowchart illustrating an example method of operating an image processing apparatus, according to various embodiments. FIG. 12 is a block diagram illustrating an example configuration of an image processing apparatus for performing an image processing operation, according to various embodiments.

Referring to FIG. 11, in operation 1110, the image processing apparatus 100 may obtain input source information and quality value of an input image. In operation 1120, the image processing apparatus 100 may obtain, based on quality statistic data corresponding to an input source, model set information mapped to a quality interval corresponding to the quality value of the input image and pre-stored. In operation 1130, the image processing apparatus 100 may control a second processor to assign resources of the second processor to one or more models included in an obtained model set, according to resource distribution proportions. Operations 1110 to 1130 correspond to operations 510 to 530 of FIG. 5.

In operation 1140, the image processing apparatus 100 may identify whether a confidence level of the quality statistic data corresponding to the input source of the input image is more than or less than a threshold value. The confidence level of the quality statistic data may vary for each input source. The confidence level may indicate a quality accumulated frequency of an image.

In an embodiment of the disclosure, when the confidence level of the quality statistic data is low (operation 1140 – no), the image processing apparatus 100 may determine to learn one or more models included in the obtained model set and perform operation 1150. In operation 1150, the image processing apparatus 100 may update a parameter for each model. The image processing apparatus 100 may quickly learn and update by increasing a speed of updating the parameter of the model. Accordingly, a high quality image may be quickly provided to a user.

On the other hand, when the confidence level of the quality statistic data is high (operation 1140 – yes) in an embodiment of the disclosure, the image processing apparatus 100 may not learn the one or more models included in the model set but use the one or more models for image processing. In other words, the image processing apparatus 100 may perform operation 1160. In operation 1160, the image processing apparatus 100 may control the second processor to generate an output image by image-processing the input image through the one or more models to which the resources of the second processor have been assigned according to the resource distribution proportions. In other words, the image processing apparatus 100 may immediately load models most appropriate to the input image and support optimal image quality to be viewed. Alternatively, the image processing apparatus 100 may learn the one or more models while reducing the speed of updating the parameter of the model, thereby maintaining stable image quality.

In a case of image quality frequency viewed by the user, it is highly likely that the quality value of the input image belongs to a confidence interval of the quality statistic data, and thus, the models may have been optimized. In this case, parameter update may be omitted to quickly provide a high quality image to the user.

On the other hand, in a case of image quality not frequently viewed by the user, it is less likely that the quality value of the input image belongs to the confidence interval of the quality statistic data, and thus, a model parameter update may be required.

When the confidence level of the quality statistic data corresponding to the input source is low, the image processing apparatus 100 according to an embodiment of the disclosure may interpolate a plurality of models and load the interpolated models. On the other hand, when the confidence level of the quality statistic data is high, the image processing apparatus 100 may load only a parameter of a single model at a specific location.

Referring to FIG. 12, the image processing apparatus 100 according to an embodiment of the disclosure differs from the image processing apparatus 100 of FIG. 10 in that a model learner (e.g., including various circuitry and/or executable program instructions) 1230 is further included. For example, the image processing apparatus 100 may include a quality analyzer 1210, a model obtainer 1220, the model learner 1230, , and an image processor (e.g., including circuitry) 1240. The image processing apparatus 100 may include a quality statistic data storage 1250 and a model parameter dataset storage 1260. The quality analyzer 1210 may correspond to the quality analyzer 1010, the model obtainer 1220 may correspond to the model obtainer 1020, and the image processor 1240 may correspond to the image processor 1030. The quality statistic data storage 1250 may correspond to the quality statistic data storage 1040 and the model parameter dataset storage 1260 may correspond to the model parameter dataset storage 1050.

For example, the model obtainer 1220 may identify a model set and transmit information about one or more models included in the identified model set to the model learner 1230. The model learner 1230 may perform a parameter update on the one or more models. The model learner 1230 may transmit, to the image processor 1240, information about the models on which the parameter update has been performed. The image processor 1240 may load, onto a second processor, the models that are updated in the model learner 1230, and process image quality of an input image.

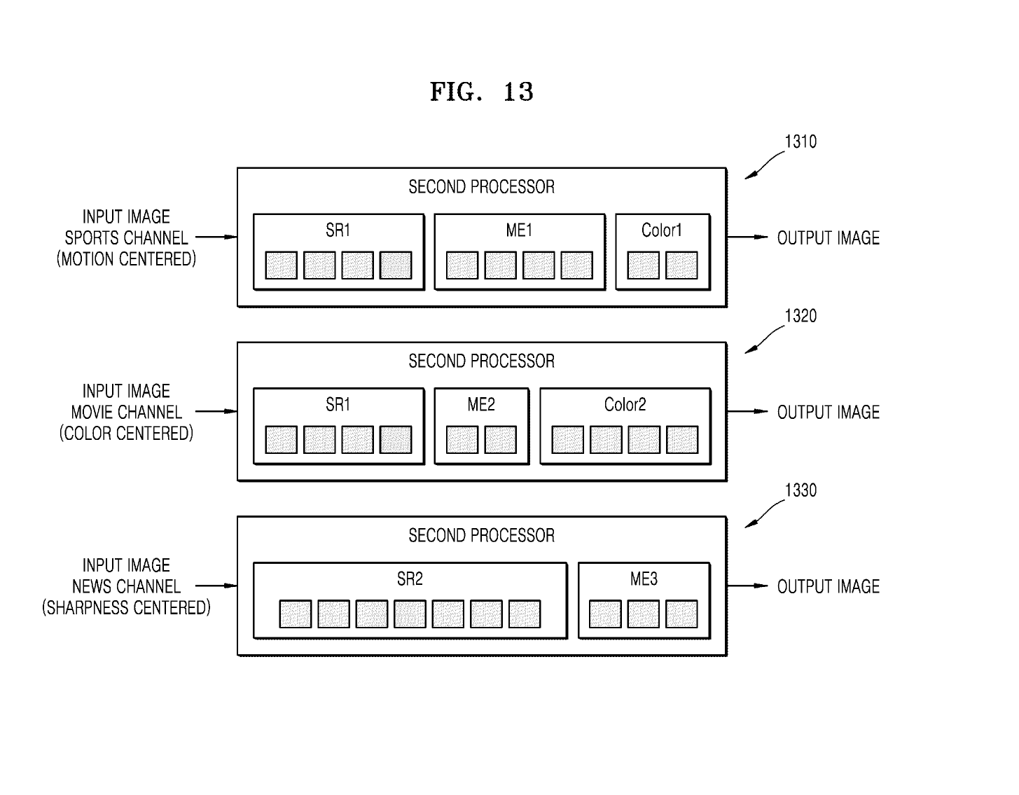

Hereinafter, a model set and a resource distribution proportion, which vary according to an input source, quality, and content of an input image, will be described in greater detail with reference to FIGS. 13 to 16. SR, ME, and Color illustrated in each drawing may respectively indicate an upscaling model (or a super-resolution model), a motion estimation model, and a color correction model.

The upscaling model may refer to a neural network that learns a difference between a low-resolution image and a high-resolution image, and obtains, from a low-resolution image, a high-resolution image that is sharper and more detailed. For example, the upscaling model may include various neural networks, such as a 2k-to-4k upscaling model, a 4k-to-8k upscaling model, a 4k-to-4k upscaling model, and a 8k-to-8k upscaling model, according to an input resolution and an output resolution. These upscaling models may have different architectures.

For example, a resolution may include standard definition (SD), high definition (HD), full high definition (FHD), quad high definition (QHD), 4K ultra high definition (UHD), 8K UHD, or greater.

The 2k-to-4k upscaling model may include a neural network configured to execute a 2k-to-4k upscaling algorithm for generating an output image with a resolution of 4k from an input image with a resolution of 2k (or below 2k). The 2k-to-8k upscaling model and the 4k-to-8k upscaling model may operate in a same manner as the 2k-to-4k upscaling model, except that input/output resolutions are different.

The 4k-to-4k upscaling model may include a neural network configured to, instead of adjusting a size of an image, improve quality of an image by generating texture of an image of 4k resolution or by enhancing sharpness.

The motion estimation model includes a neural network configured to estimate motion between frames of an image and extract the motion in the form of a motion vector. The motion vector extracted from the motion estimation model may be later input to a motion compensation circuit implemented in a video processor. The motion compensation circuit may compensate for a new frame using the received motion vector to obtain an image of a high frame rate from an image of a low frame rate. An FRC algorithm may be performed through the motion estimation model and the motion compensation circuit. However, the disclosure is not limited thereto, and the motion compensation circuit may be replaced with a motion compensation model executed by a second processor.

The color correction model may include a neural network configured to perform an image color correction model improvement algorithm, a display distribution calibration algorithm (e.g., color, brightness, or color temperature calibration), a tone mapping algorithm, a high dynamic range (HDR) image processing algorithm, or the like.

However, descriptions about each model are only examples, and various types of models other than SR, ME, and Color may be used. SR1, SR2, and the like illustrated in the drawings indicate a same image processing function but different model parameter datasets and different resource proportions. The terms SR1, SR2, and the like are used as same terms throughout FIGS. 13 to 16, but the resource proportions defined in the drawings are valid only within the respective drawing and do not affect other drawings. Rectangular blocks included in each model may correspond to an MAC arithmetic operator, an ALU arithmetic operator, and the like, which are included in an arithmetic operator (e.g., an arithmetic operator 124 of FIG. 18) of a second processor. It is assumed that the total number of arithmetic operators included in the second processor is 10.

FIG. 13 is a diagram illustrating an example model set and a resource distribution proportion, which are different for each channel of an input image, according to various embodiments. In FIG. 13, it is assumed that the image processing apparatus 100 receives broadcast content from a set-top box physically connected through HDMI.

Referring to reference numerals 1310 to 1330, resource distribution states of a second processor are illustrated in a case where an input image is received from a sports channel (see the reference numeral 1310), a case where an input image is received from a movie channel (see the reference numeral 1320), and a case where an input image is received from a news channel (see the reference numeral 1330).

Referring to FIG. 13, the image processing apparatus 100 may store quality statistic data for each channel of the broadcast content. For example, the image processing apparatus 100 may separately store corresponding quality statistic data when a channel of the broadcast content is the sports channel, corresponding quality statistic data when the channel is the movie channel, and corresponding quality statistic data when the channel is the news channel. The quality statistic data corresponding to each channel may include model set information (e.g., combination information of one or more models, identification information of one or more models, and resource distribution proportion information) respectively mapped to a plurality of quality intervals included in the quality statistic data. For example, the quality statistic data corresponding to the sports channel may include model set information about "SR1:ME1:Color1=40%:40%:20%". For example, the quality statistic data corresponding to the movie channel may include model set information about "SR1:ME2:Color2=40%:20%:20%". For example, the quality statistic data corresponding to the news channel may include model set information about "SR2:ME3 =70%:30%". Because the sports channel is motion focused, resource proportions of SR and ME may be greater than a resource proportion of Color. Because the movie channel is color focused, resource proportions of SR and Color may be greater than a resource proportion of ME. Because the news channel is sharpness focused, a resource proportion of SR may be greatest.

Referring to reference numeral 1310, when an input source is the sports channel, the image processing apparatus 100 may select model set 1 in which a resource distribution proportion of ME is a selected value (e.g., 40%) or more. The second processor stores parameter datasets of SR1, ME1, and Color1, and resources of the second processor may be assigned in proportions of SR1:ME1:Color1 = 40%:40%:20%.

Referring to reference numeral 1320, when an input source is the movie channel, the image processing apparatus 100 may select model set 2 in which a resource distribution proportion of Color is a selected value (e.g., 40%) or more. The second processor stores parameter datasets of SR1, ME2, and Color2, and resources of the second processor may be assigned in proportions of SR1:ME2:Color2 = 40%:20%:40%.

Referring to reference numeral 1330, when an input source is the news channel, the image processing apparatus 100 may select model set 3 in which a resource distribution proportion of SR is a selected value (e.g., 70%) or more. The second processor stores parameter datasets of SR3 and ME3, and resources of the second processor may be assigned in proportions of SR2:ME3 = 70%:30%.

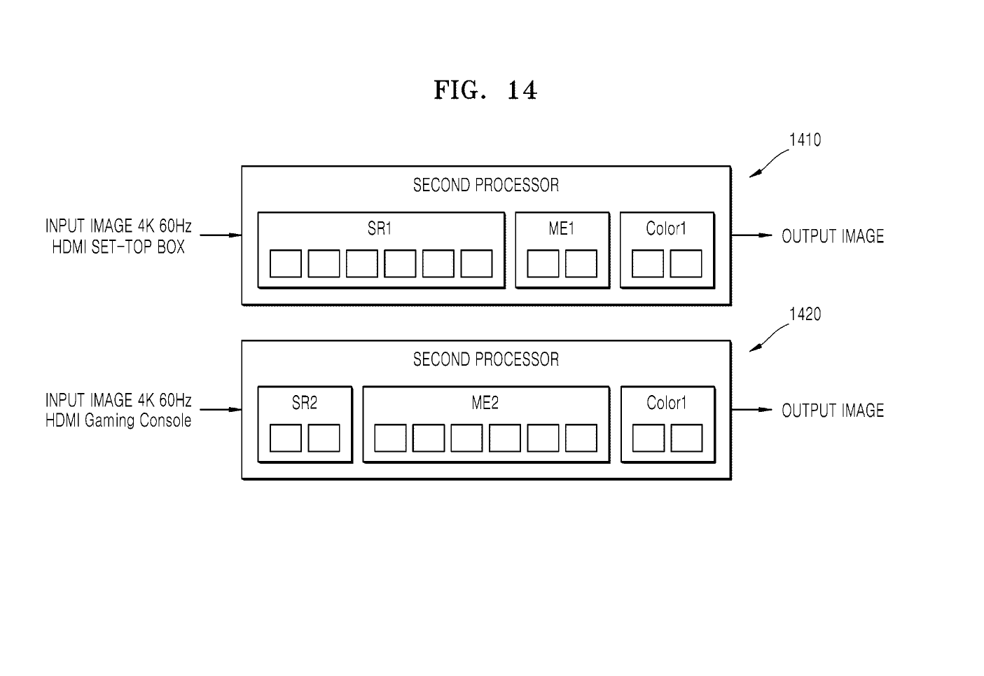

FIG. 14 is a diagram illustrating an example model set and a resource distribution proportion, which are different for each input source connected to HDMI, according to various embodiments. In FIG. 14, it is assumed that resolution information of an image input to the image processing apparatus 100 is 4k and frame rate information is 60 Hz.

Referring to reference numeral 1410, a resource distribution state of a second processor is illustrated in a case where an input source of an input image is a set-top box physically connected to HDMI. Referring to reference numeral 1420, a resource distribution state of a second processor is illustrated in a case where an input source of an input image is a gaming console device physically connected to HDMI.

The image processing apparatus 100 may store quality statistic data for each input source of an image. For example, the image processing apparatus 100 may separately store quality statistic data when an input source corresponds to the set-top box and quality statistic data when an input source corresponds to the gaming console device. The quality statistic data corresponding to each input source may include model set information (e.g., combination information of one or more models, identification information of one or more models, and resource distribution proportion information) respectively mapped to a plurality of quality intervals included in the quality statistic data. For example, the quality statistic data corresponding to the set-top box may include model set information about "SR1:ME1:Color1=60%:20%:20%". For example, the quality statistic data corresponding to the gaming console device may include model set information about "SR2:ME2:Color1=20%:60%:20%". When the input source is the set-top box, an input image has a small amount of motion, and thus, a resource proportion of SR may be greater than a resource proportion of ME. When the input source is the gaming console device, an input image has a large amount of motion, and thus, a resource proportion of ME may be greater than a resource proportion of SR.

Referring to reference numeral 1410, when the input source of the input image is the set-top box, the image processing apparatus 100 may select a model set 1 in which a resource distribution proportion of SR is greater than a resource distribution proportion of ME. The second processor stores parameter datasets of SR1, ME1, and Color1, and resources of the second processor may be assigned in proportions of SR1:ME1:Color1 = 60%:20%:20%.

Referring to reference numeral 1420, when the input source of the input image is the gaming console device, the image processing apparatus 100 may select a model set 2 in which a resource distribution proportion of ME is greater than a resource distribution proportion of SR. The second processor stores parameter datasets of SR2, ME2, and Color1, and resources of the second processor may be assigned in proportions of SR2:ME2:Color1 = 20%:60%:20%.

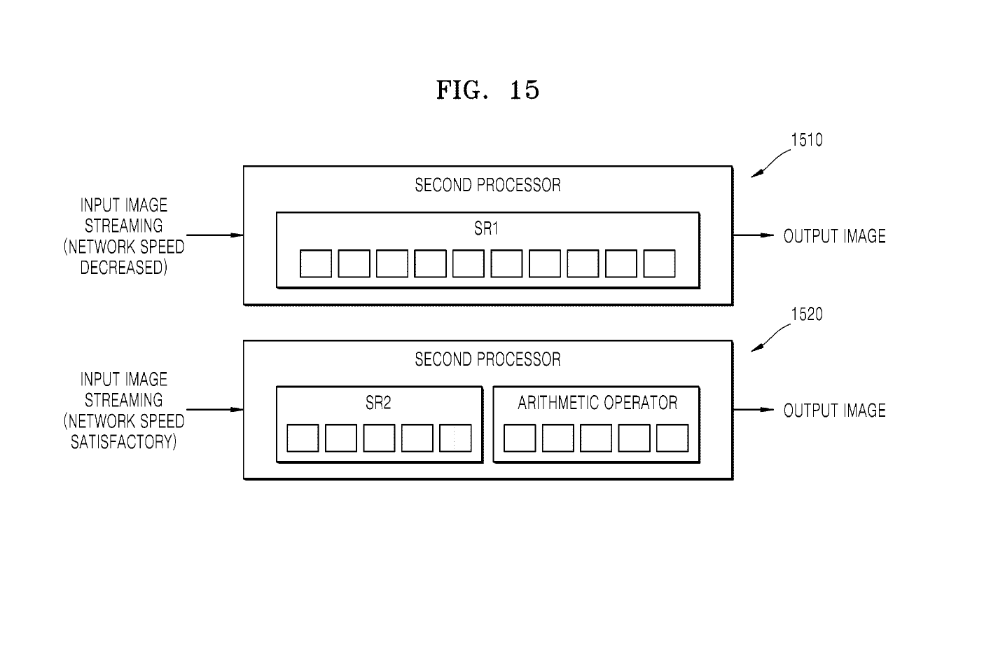

FIG. 15 is a diagram illustrating an example model set and a resource distribution proportion, which are different for each network speed of streaming content, according to various embodiments. In FIG. 15, it is assumed that the image processing apparatus 100 receives streaming content from a streaming server connected wirelessly through a communicator.

Referring to reference numerals 1510 and 1520, resource distribution states of a second processor are illustrated in a case where a network speed of streaming content is decreased (see the reference numeral 1510) and a case where a network speed of the streaming content is satisfactory (see the reference numeral 1520). The network speed may also be referred to as a streaming speed.

Referring to FIG. 15, the image processing apparatus 100 may store model set information for each quality of streaming content.

For example, even when a same device and a same network are used at a same place to view streaming content received through a streaming server, image quality of an image may vary depending on time. For example, because data of the streaming content is received through the Internet, a data transmit speed may vary when an Internet bandwidth of the streaming server is changed according to time. A difference in the data transmit speed may cause a difference in the image quality of the streaming content. Also, for example, the streaming server simultaneously provides a service to several users, and the server may be overloaded when a large number of people access at a specific time zone. Accordingly, the image quality of the streaming content may deteriorate. Also, for example, the streaming server may manage traffic by adjusting an Internet speed. Accordingly, the image quality of the streaming content may deteriorate when the streaming server restricts the Internet speed at a specific time zone. For example, the image quality of the streaming content may deteriorate when a device performance is low. For example, when the image processing apparatus 100 uses a lot of resources for another system, the image quality of the streaming content may deteriorate compared to a high-specification latest device. For example, the streaming servers use various methods of compressing (encoding) content. Accordingly, even for same content, the image quality of the streaming content may vary depending on a compression method of the streaming server, for each channel. For example, quality of content itself provided by the streaming server may be affected. For example, the image quality of the streaming content may deteriorate when a resolution of original content is low or due to a lighting condition at the time of photographing.

In the above examples, image quality of an image may vary according to time even when a same place, a same device, and a same network are used when viewing streaming content. Accordingly, the image processing apparatus 100 may separately store model set information corresponding to a quality interval when the network speed of the streaming content is decreased, and model set information corresponding to a quality interval when the network speed is satisfactory. The model set information may be mapped to each of a plurality of quality intervals in quality statistic data corresponding to the streaming content, and stored. For example, the image processing apparatus 100 may separately map the model set information for each of the plurality of quality intervals in the quality statistic data corresponding to the streaming content, and store the same.

Referring to reference numeral 1510, the model set information corresponding the quality interval when the network speed of the streaming content is decreased may include information about "SR1=100%". Because quality of an image deteriorates when the network speed is decreased, a resource proportion of SR needs to be the greatest. The image processing apparatus 100 may select a model set 1 in which a resource distribution proportion of SR is the greatest, based on the model set information. The second processor stores a parameter dataset of SR1 and resources of the second processor may be assigned in a proportion of SR1 = 100%.

Referring to reference numeral 1520, the model set information corresponding the quality interval when the network speed of the streaming content is satisfactory may include information about "SR2=50%". When the network speed is satisfactory, a resource proportion of SR may be less required, and because resources of the second processor are not used as much as unused resources, power consumption may be reduced. The image processing apparatus 100 may select a model set 2 in which a resource distribution proportion of SR corresponds to a selected value (e.g., 50%), based on the model set information. The second processor stores a parameter dataset of SR2 and resources of the second processor may be assigned in a proportion of SR2 = 50%.

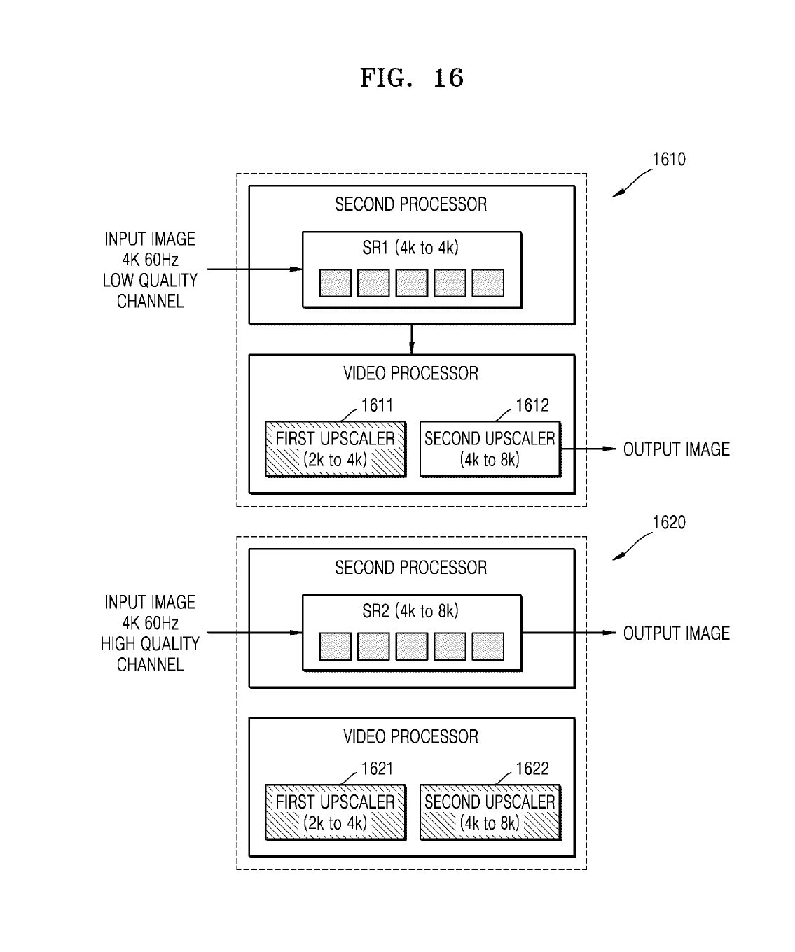

FIG. 16 is a diagram illustrating an example model set and a resource distribution proportion, which are different for each quality of an input image, according to various embodiments. In FIG. 16, it is assumed that resolution information of an image input to the image processing apparatus 100 is 4k and frame rate information is 60 Hz.

FIG. 16 illustrates a state in which resources of a second processor are assigned to SR1 corresponding to a 4k-to-4k upscaling model and SR2 corresponding to a 4k-to-8k upscaling model. Roles thereof have been described above. FIG. 16 illustrates a video processor including a first upscaler (e.g., including circuitry and/or executable program instructions) 1611 or 1621 and a second upscaler (e.g., including various circuitry and/or executable program instructions) 1612 or 1622. The video processor may include various processing circuitry, including, for example, a processor configured to execute an image processing circuit. The video processor may be a processor specialized for image processing and may include a hardware configuration, circuit, or logic required for the image processing. For example, the video processor may include at least one of an application-specific integrated circuit (ASIC) or a field programmable gate array (FPGA), but is not limited thereto. A first upscaler may include an image processing circuit implementing a 2k-to-4k upscaling algorithm. A second upscaler may include an image processing circuit implementing a 4k-to-8k upscaling algorithm.

Referring to reference numerals 1610 and 1620, resource distribution states of the second processor are illustrated in a case where an input image is received through a low quality channel (see the reference numeral 1610 and a case where an input image is received through a high quality (see the reference numeral 1620). For example, even when input images have a same resolution and a same frame rate, qualities of the images may vary depending on a network transmission speed, a compression degree, or the like. For example, a low quality image may be an image in which a compression deterioration degree, a blur degree, a deterioration degree, sharpness, a noise degree, and an image resolution are deteriorated. For example, a high quality image may include frequency information (e.g., sharpness or detail) in units of pixels.

The image processing apparatus 100 may store model set information for each quality of an image. For example, the image processing apparatus 100 may separately store model set information corresponding to a case where an input source is low quality and model set information corresponding to a case where an input source is high quality. The model set information may be mapped to each of a plurality of quality intervals in quality statistic data corresponding to a broadcast channel, and stored. For example, the image processing apparatus 100 may separately store model set information for each of a plurality of quality intervals in quality statistic data corresponding to a specific channel of broadcast content. The model set information corresponding to low quality may include information about a model set 1, for example, "SR1(4k-to-4k)=50%". The model set information corresponding to high quality may include information about a model set 2, for example, "SR2(4k-to-8k)=50%".

Referring to reference numeral 1610, when an input source is low quality, the image processing apparatus 100 may perform image processing using SR1 (4k-to-4k) in which an input resolution and an output resolution are the same as a resolution of an input image, so as to generate texture in an image or strengthen sharpness. SR1 (4k-to-4k) in which an input resolution and an output resolution are the same may improve quality of an image instead of adjusting a size of the image. In this case, the first upscaler 1611 may be deactivated and the second upscaler 1612 may be activated. The image processing apparatus 100 may input, to the second upscaler 1612, an upscaled 4k image output through SR1 (4k-to-4k). The second upscaler 1612 may receive the upscaled 4k image, perform upscaling, and output an 8k image.

When an input image is low quality, the image processing apparatus 100 may select the model set 1 in which resources are distributed to SR1 (4k-to-4k). The second processor may store parameter datasets of SR1 (4k-to-4k) and assign resources of the second processor in a proportion of SR1 (4k-to-4k) = 50%.

Referring to reference numeral 1620, when an input source is high quality, the image processing apparatus 100 may perform image processing using SR2 (4k-to-8k) in which an input resolution is the same as a resolution (e.g., 4k) of an input image and an output resolution is the same as a target resolution (e.g., 8k). In this case, the first upscaler 1621 and the second upscaler 1622 may be deactivated. The image processing apparatus 100 may perform upscaling on a 4k image through SR2 (4k-to-8k) and output an 8k image.

When an input image is high quality, the image processing apparatus 100 may select the model set 2 in which resources are distributed to SR1 (4k-to-8k). The second processor stores parameter datasets of SR2 (4k-to-8k), and resources of the second processor may be assigned in a proportions of SR2 (4k-to-8k) = 50%.

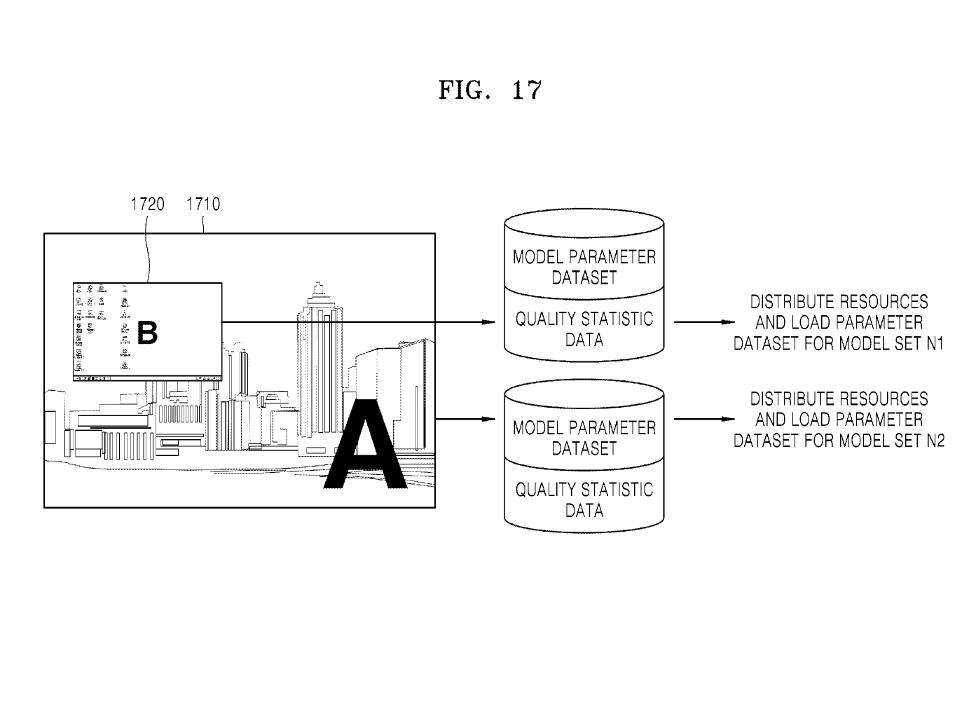

FIG. 17 is a diagram illustrating an example operation in which an image processing apparatus determines a model set for multi-content, according to various embodiments.

Referring to FIG. 17, the image processing apparatus 100 according to an embodiment of the disclosure may display multi-content on a display. The multi-content may include a first image 1710 and a second image 1720. The first image 1710 may correspond to an image received from an input source. The second image 1720 may include a picture-in-picture (PIP) or a picture-outside-picture (POP). The PIP may be a small screen inserted into one big screen, e.g., may be an auxiliary screen. The POP may be obtained by displaying, separately in parallel, two or more pieces of content on a same screen. The second image 1720 may also correspond to an image received from the input source or may be an image generated by the image processing apparatus 100.

The image processing apparatus 100 according to an embodiment of the disclosure may perform an image processing preparation operation on each of the first image 1710 and the second image 1720.

The image processing apparatus 100 according to an embodiment of the disclosure may, based on a quality statistic data storage and a model parameter dataset storage for the first image 1710, identify a model set N1 corresponding to the first image 1710, and distribute resources and load a parameter dataset for the model set N1. Details thereof have been described above.

The image processing apparatus 100 according to an embodiment of the disclosure may perform the image processing preparation operation based on the second image 1720. The image processing apparatus 100 may, based on a quality statistic data storage and a model parameter dataset storage for the second image 1720, identify a model set N2 corresponding to the second image 1720, and distribute resources and load a parameter dataset for the model set N2. In this case, the image processing apparatus 100 may separately store quality statistic data for the PIP or POP. The image processing apparatus 100 may use, for the second image 1720, quality statistic data for each input source, pre-stored to be used in the first image 1710.

FIG. 18 is a block diagram illustrating an example configuration of an image processing apparatus, according to various embodiments.

Referring to FIG. 18, the image processing apparatus 100 according to an embodiment of the disclosure may include the first processor (e.g., including processing circuitry) 110, a second processor (e.g., including processing circuitry) 120, memory 130, and the image receiver (e.g., including various circuitry) 140.

The first processor 110 may include various processing circuitry as described above and control the image processing apparatus 100 in general. The first processor 110 according to an embodiment of the disclosure may execute one or more programs stored in the memory 130. The first processor 110 according to an embodiment of the disclosure may include one or more processors.

The one or more processors included in the first processor 110 may include a general-purpose processor, such as a central processing unit (CPU), an application processor (AP), or a digital signal processor (DSP), a graphic-dedicated processor, such as a graphics processing unit (GPU) or a vision processing unit (VPU), or an artificial intelligence-dedicated processor, such as a neural processing unit (NPU). Alternatively, according to an embodiment of the disclosure, the first processor 110 may include circuitry implemented in the form of an integrated circuit (IC) or a system-on-chip (SoC) in which at least one of CPU, GPU, VPU, or NPU are integrated (see, e.g., detailed description “processor” and/or “model” above).

The memory 130 may store various pieces of data, programs, or applications to drive and control the image processing apparatus 100. The program stored in the memory 130 may include one or more instructions. The program (one or more instructions) or application stored in the memory 130 may be executed by the first processor 110.

The memory 130 is a configuration for storing various programs or data, and may include a storage medium such as ROM, RAM, hard disk, CD-ROM, or DVD, or a combination of the storage media. The memory 130 may not be present separately but may be included in the first processor 110. The memory 130 may be configured in volatile memory, nonvolatile memory, or a combination of volatile memory and nonvolatile memory. The memory 130 may store a program or at least one instruction for performing operations according to embodiments of the disclosure described below. The memory 130 may provide stored data to the first processor 110 according to a request of the first processor 110.

The image receiver 140 may include various circuitry and receive an image from an external device. The image receiver 140 may include at least one of a tuner, a communicator, or an input/output unit. The tuner may tune and select only a frequency of a channel to be received by the image processing apparatus 100 from among many radio wave components by performing amplification, mixing, and resonance on broadcast content received via wires or wirelessly according to control by the first processor 110. The input/output unit may receive, from the external device according to control by the first processor 110, video (e.g., a dynamic image signal or a still image signal), audio (e.g., a voice signal or a music signal), and additional information. The communicator may connect the image processing apparatus 100 to a peripheral device, an external device, a server, or a mobile terminal, according to control by the first processor 110. The communicator may include various communication circuits included in at least one communication module. The communicator may include a short-range communication module, a wireless Internet module, or a wired Ethernet.

The second processor 120 may include an artificial intelligence-dedicated processor specialized for a neural network arithmetic operation. The second processor 120 may include one or more processors configured to execute a neural network. The one or more processors included in the second processor 120 may include GPU, NPU, or a tensor processing unit (TPU). The second processor 120 may be manufactured in the form of a dedicated hardware chip for artificial intelligence or may be manufactured as a part of an existing general-purpose processor (e.g., CPU or AP) or a part of a graphics-dedicated processor (e.g., GPU). The second processor 120 may be implemented in the form of one chip integrated with the first processor 110 as described in greater detail above..

The second processor 120 according to an embodiment of the disclosure may include a controller 122, the arithmetic operator 124, and internal memory 126. The second processor 120 may include at least one of hardware resources, software resources, or logic resources required or used to execute various neural network models.

The controller 122 may include a scheduler configured to control an arithmetic operation of the arithmetic operator 124 for inference of the second processor 120, and a read and write order of the internal memory 126. The scheduler in the controller 122 may include a circuit configured to control the arithmetic operator 124 and the internal memory 126. The controller 122 may control inference of a neural network model of the second processor 120.

The arithmetic operator 124 may include a plurality of arithmetic operators configured to perform multiplication, addition, convolution, and the like on the neural network model. The plurality of arithmetic operators may be arranged in the second processor 120 to calculate weight data and a feature map of the neural network model. The arithmetic operators may include a multiply and accumulate (MAC) arithmetic operator and an arithmetic logic unit (ALU) arithmetic operator. The MAC arithmetic operator may include a multiplier, an adder, and an accumulator. For example, the arithmetic operator 124 may include a plurality of MAC arithmetic operators. The plurality of MAC arithmetic operators may be arranged in parallel in the second processor 120. However, an embodiment of the disclosure is not limited thereto.

The total number of arithmetic operators included in the arithmetic operator 124 is 9, but is not limited thereto. The nine arithmetic operators are displayed as rectangles indicated by M1, M2, M3, M4, M5, M6, M7, M8, and M9.

The internal memory 126 may store information about a plurality of neural network models. The neural network model may include image processing neural networks for various purposes into to the image processing apparatus 100. The internal memory 126 in the second processor 120 may temporarily store parameters, such as an input feature map, an output feature map, an activation map, and a weight kernel, for arithmetic operation of the neural network model. Accordingly, the internal memory 126 in the second processor 120 may include an input feature map storage, an output feature map storage, and a weight storage.

In an embodiment of the disclosure, the internal memory 126 may store a neural network model, a parameter of the neural network model, and video data corresponding to an input image and an output image.

In an embodiment of the disclosure, the memory 130 may store information about a plurality of neural network models. The neural network model may include a convolutional neural network (CNN) and a recurrent neural network (RNN). Alternatively, the neural network model may include a region-based CNN (R-CCN), a spatial pyramid pooling network (SPP-Net), you only look once (YOLO), a single-shot multibox detector (SSD), a deconvolutional single-shot multibox detector (DSSD), long-short term memory (LTSM), and a gated recurrent unit (GRU). The information about the plurality of neural network models may be stored in memory.

In an embodiment of the disclosure, the memory 130 may include the model parameter dataset storage. The model parameter dataset storage may store information about a plurality of neural network model configured to perform various image processing functions. For example, the neural network model may include an upscaling model capable of converting a low resolution image into a high resolution image. For example, the upscaling model may include various neural networks, such as a 2k-to-4k upscaling model, a 4k-to-8k upscaling model, a 4k-to-4k upscaling model, and a 8k-to-8k upscaling model, according to an input resolution and an output resolution. For example, the neural network model may include an FRC model implementing an FRC algorithm, a motion estimation model, and a motion compensation model. For example, the neural network model may include a color correction model. For example, the neural network model may include a CE (or contrast expansion) model. For example, the neural network model may include an image quality analysis model (or a quality analyzer) configured to analyze image quality or quality of an input image. For example, the image quality analysis model may obtain characteristic information of an image, for example, a compression deterioration degree, a blur degree, a deterioration degree, sharpness, a noise degree, and a resolution of the image. For example, the plurality of neural network models may include a classification model configured to identify a genre of an input image. For example, the classification model may identify and classify a genre of an input image, for example, a movie, a documentary, news, sports, or animation.

In an embodiment of the disclosure, the memory 130 may include the quality statistic data storage. The quality statistic data storage may store a plurality of pieces of quality statistic data indicating an accumulated frequency according to quality of an image input for each input source. The quality statistic data storage may store information about one or more models.

In an embodiment of the disclosure, the memory 130 may include at least one of a quality analyzer, a model obtainer, a model learner, or an image processor. The quality analyzer, the model obtainer, the model learner, and the image processor may include software, such as program code, an instruction, an algorithm, or a data structure, which is executed by the first processor 110. The quality analyzer, the model obtainer, the model learner, and the image processor may be software modules in which operations performed by the first processor 110 are classified according to functions or purposes. This has been described above with reference to FIGS. 10 and 12.

In an embodiment of the disclosure, the first processor 110 may execute one or more instructions stored in the memory 130 to obtain input source information and a quality value of an input image. The first processor 110 may execute the one or more instructions stored in the memory 130 to identify quality statistic data corresponding to the input source information of the input image from among a plurality of pieces of quality statistic data indicating an accumulated frequency according to quality of an image input for each input source. The first processor 110 may execute the one or more instructions stored in the memory 130 to obtain information about one or more models pre-stored in the identified quality statistic data. The first processor 110 may execute the one or more instructions stored in the memory 130 to, during a determined resource distribution interval, control the second processor 120 to assign resources of the second processor 120 to the one or more models, based on the information about the one or more models. The first processor 110 may execute the one or more instructions stored in the memory 130 to, based on the information about the one or more models, load, onto the second processor 120, a parameter dataset of the one or more models from among parameter datasets for a pre-stored plurality of models. The first processor 110 may execute the one or more instructions stored in the memory 130 to obtain an output image obtained by image-processing the input image, through the one or more models executed by the second processor 120.

In an embodiment of the disclosure, the first processor 110 may execute the one or more instructions stored in the memory 130 to control the second processor 120 to assign the resources of the second processor 120 to the one or more models, based on the identification information about the one or more models and the resource distribution proportion information of the second processor 120 for the one or more models, included in the information about the one or more models.

In an embodiment of the disclosure, a determined resource distribution interval may indicate an interval in which the input image is not output. In an embodiment of the disclosure, the first processor 110 may execute the one or more instructions stored in the memory 130 to, during the determined resource distribution interval, load parameter datasets of the one or more models onto the second processor 120 and control the second processor 120 to assign the resources of the second processor 120 to the one or more models.

Accordingly, the image processing apparatus 100 according to an embodiment of the disclosure may quickly perform an image processing preparation operation before image processing using the quality statistic data pre-mapped to the information about the one or more models and stored, and the parameter datasets of models in which the identification information of the one or more models and the parameter datasets are paired and stored. Thus, the image processing preparation operation may be performed during the determined resource distribution interval.

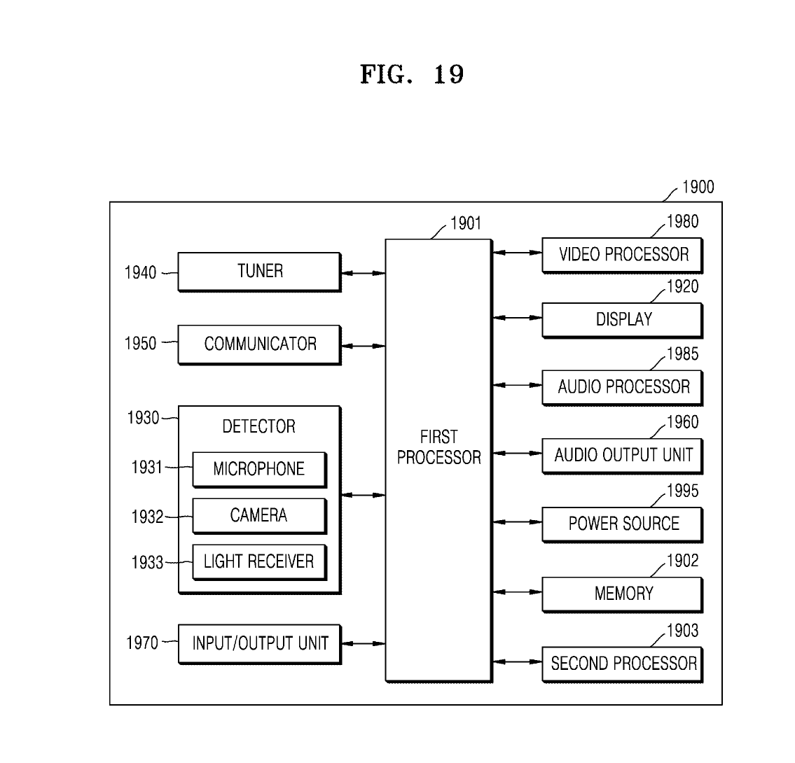

FIG. 19 is a block diagram illustrating an example configuration of an image processing apparatus according to various embodiments.

Referring to FIG. 19, an image processing apparatus 1900 may include a tuner 1940, a first processor 1901, memory 1902, a second processor 1903, a display 1920, a communicator 1950, a detector 1930, an input/output unit 1970, a video processor 1980, an audio processor 1985, and audio output unit 1960, and a power source 1995. The image processing apparatus 1900 may correspond to the image processing apparatus 100 of FIG. 18. The first processor 1901, the memory 1902, and the second processor 1903 may respectively correspond to the first processor 110, the memory 130, and the second processor 120 of FIG. 18. The tuner 1940, the communicator 1950, and the input/output unit 1970 may correspond to the image receiver 140 of FIG. 18.

The tuner 1940 may tune and select only a frequency of a channel to be received by the image processing apparatus 1900 from among many radio wave components by performing amplification, mixing, and resonance on a broadcast signal received via wires or wirelessly. The broadcast signal includes audio, video, and additional information (for example, an electronic program guide (EPG)).

The tuner 1940 may receive a broadcast signal from various sources, such as terrestrial broadcasting, cable broadcasting, satellite broadcasting, and Internet broadcasting. The tuner 1940 may receive a broadcast signal from a source such as analog broadcasting or digital broadcasting.

The communicator 1950 may include various communication circuitry and transmit and/or receive data or a signal to and from an external device or a server. For example, the communicator 1950 may include a Wi-Fi module, a Bluetooth module, an infrared communication module, a wireless communication module, a local area network (LAN) module, an Ethernet module, or a wired communication module. Here, each communication module may be implemented in the form of at least one hardware chip.

The Wi-Fi module and the Bluetooth module may communicate through a W-Fi method and a Bluetooth method, respectively. When the Wi-Fi module or the Bluetooth module is used, various types of connection information, such as a service set identifier (SSID) or a session key, may be transmitted or received first, communication may be connected using the same, and then various types of information may be transmitted or received. The wireless communication module may include at least one communication chip performing communication according to various wireless communication standards, such as ZigBee, 3rd generation (3G), 3G partnership project (3GPP), long-term evolution (LTE), LTE advanced (LTE-A), 4th generation (4G), and 5th generation (5G).

The detector 1930 according to an embodiment of the disclosure may include various circuitry and/or executable program instructions and detect a speech of a user, an image of the user, or an interaction of the user, and may include a microphone 1931, a camera 1932, and a light receiver 1933.

The microphone 1931 receives a speech uttered by the user. The microphone 1931 may convert the received speech into an electric signal and output the electric signal to the first processor 1901.

The light receiver 1933 receives an optical signal (including a control signal) received from the external control device through a light window (not shown) of a bezel of the display 1920. The light receiver 1933 may receive an optical signal corresponding to a user input (for example, touch, press, touch gesture, speech, or motion) from the control device. A control signal may be extracted from the received optical signal under control by the first processor 1901.

The input/output unit 1970 may include various circuitry and receive video (e.g., a moving image), audio (e.g., speech or music), and additional information (e.g., electronic program guide (EPG)) from the outside of the image processing apparatus 1900. The input/output unit 1970 may include any one of a high-definition multimedia interface (HDMI), a mobile high-definition link (MHL), a universal serial bus (USB), a display port (DP), a thunderbolt, a video graphics array (VGA) port, an RGB port, a D-subminiature (D-SUB), a digital visual interface (DVI), a component jack, and a PC port.

The video processor 1980 may include various circuitry and/or executable program instructions and performs processes on video data received by the image processing apparatus 1900. The video processor 1980 may perform various types of image processing on the video data, such as decoding, scaling, noise removal, FRC, and resolution conversion. For example, the video processor 1980 may decode input video data and scale the decoded video data to have a size of a frame to be output on a display. The video processor 1980 may generate an output image obtained by performing image processing, by applying various image processing algorithms on an input image.

The video processor 1980 according to an embodiment of the disclosure may include the video processor of FIGS. 13 to 16. The video processor 1980 may perform image processing according to control by the first processor 1901. The video processor 1980 may include a processor configured to execute an image processing circuit. The video processor 1980 is a processor specialized for image processing and may include a hardware configuration, circuit, or logic required for the image processing. For example, the video processor 1980 may include at least one of an application-specific integrated circuit (ASIC) or a field programmable gate array (FPGA), but is not limited thereto.

For example, the image processing circuit may include an upscaler. The upscaler may include a circuit for an upscaling algorithm. The upscaler may include one or more upscalers supporting image processing of different resolutions. For example, the upscaler may include at least one of a first upscaler implementing a 2k-to-4k upscaling algorithm or a second upscaler implementing a 4k-to-8k upscaling algorithm.

For example, the image processing circuit may include a color correction circuit. The color correction circuit may correspond to an image processing circuit configured to perform an image color correction model improvement algorithm, a display distribution calibration algorithm (e.g., color, brightness, or color temperature calibration), a tone mapping algorithm, a high dynamic range (HDR) image processing algorithm, or the like.

For example, the image processing circuit may include a motion compensation circuit. The motion compensation circuit may be configured to implement an algorithm of compensating for a new frame using an extracted motion vector to obtain an image of a high frame rate from an image of a low frame rate.

The second processor 1903 and the video processor 1980 may transmit and receive video data corresponding to an image using frame memory or a line buffer. The frame memory may store one or more frames. The line buffer may store, in real time, lines configuring a frame.

The first processor 1901 may include at least one of a central processing unit (CPU), a graphics processing unit (GPU), or a video processing unit (VPU). Alternatively, the first processor 1901 may be implemented in the form of a system-on-chip (SoC) in which at least one of CPU, GPU, or VPU is integrated. Alternatively, the first processor 1901 may further include a neural processing unit (NPU). Alternatively, the first processor 1901 may be a processor specialized for image processing and may include a hardware configuration, circuit, or logic required for the image processing. For example, the first processor 1901 may include at least one of an application-specific integrated circuit (ASIC) or a field programmable gate array (FPGA), but is not limited thereto.

In an embodiment of the disclosure, the first processor 110 and the second processor 120 may be implemented as one integrated chip.

The memory 1902 according to an embodiment of the disclosure may store various types of data, programs, or applications for driving and controlling the image processing apparatus 1900.

The program stored in the memory 1902 may include one or more instructions. The program (one or more instructions) or application stored in the memory 1902 may be executed by the first processor 1901.

The first processor 1901 according to an embodiment of the disclosure may execute the one or more instructions stored in the memory 1902 to obtain an input image. The input image may be an image pre-stored in the memory 1902 or an image received from an external device through the tuner 1940 or the communicator 1950. Also, the input image may be an image on which various types of image processes have been performed by the video processor 1980, such as decoding, scaling, noise removal, frame rate conversion, resolution conversion, and the like.

The display 1920 may generate a driving signal by converting an image signal, a data signal, an on-screen display (OSD) signal, or a control signal processed by the first processor 1901. The display 1920 may be implemented as a plasma display panel (PDP), a liquid crystal display (LCD), an organic light-emitting diode (OLED), or a flexible display, or may be implemented as a 3-dimensional (3D) display. The display 1920 may be configured as a touch screen to be used as an input device as well as an output device.

The audio processor 1985 may include various circuitry and/or executable program instructions and performs processing on audio data. The audio processor 1985 may perform various processing, such as decoding, amplification, or noise removal, on the audio data. The audio processor 1985 may include a plurality of audio processing modules to process audio corresponding to a plurality of pieces of content.

The audio output unit 1960 includes various circuitry and outputs audio included in a broadcast signal received via the tuner 1940 under control by the first processor 1901. The audio output unit 1960 may output the audio (for example, speech or sound) input through the communicator 1950 or the input/output unit 1970. The audio output unit 1960 may output audio stored in the memory 1902 under control by the first processor 1901. The audio output unit 1960 may include at least one of a speaker, a headphone output terminal, or a Sony/Philips digital interface (S/PDIF) terminal.

The power source 1995 may include a power supply and supplies power input from an external power source to components inside the image processing apparatus 1900 under control by the first processor 1901. The power source 1995 may supply power output from one or more batteries (not shown) located inside the image processing apparatus 1900 to the components inside the image processing apparatus 1900 under control by the first processor 1901.

The memory 1902 may store various types of data, programs, or applications for driving and controlling the image processing apparatus 1900 under control by the first processor 1901.

An image processing apparatus according to an example embodiment of the disclosure includes memory including at least one storage medium storing one or more instructions, at least one first processor configured to execute the one or more instructions, and a second processor configured to perform image processing.

When the one or more instructions are executed by the at least one first processor individually or collectively according to an embodiment of the disclosure, the image processing apparatus obtains input source information and a quality value of an input image.

When the one or more instructions are executed by the at least one first processor individually or collectively according to an embodiment of the disclosure, the image processing apparatus identifies quality statistic data corresponding to the input source information of the input image from among a plurality of pieces of quality statistic data indicating an accumulated frequency according to quality of an image input for each input source.

When the one or more instructions are executed by the at least one first processor individually or collectively according to an embodiment of the disclosure, the image processing apparatus obtains information about at least one model for image processing, pre-stored in the identified quality statistic data.

When the one or more instructions are executed by the at least one first processor individually or collectively according to an embodiment of the disclosure, the image processing apparatus, during a determined resource distribution interval, controls the second processor to assign resources of the second processor to the at least one model, based on the information about the at least one model.

When the one or more instructions are executed by the at least one first processor individually or collectively according to an embodiment of the disclosure, the image processing apparatus, based on the information about the at least one model, loads, onto the second processor, a parameter dataset of the at least one model from among parameter datasets for a pre-stored plurality of models.

When the one or more instructions are executed by the at least one first processor individually or collectively according to an embodiment of the disclosure, the image processing apparatus obtains an output image obtained by image-processing the input image, through the at least one model executed by the second processor.

The information about the at least one model, according to an example embodiment of the disclosure, may include identification information about the at least one model, resource distribution proportion information of the second processor for the at least one model, or storage location information for the parameter dataset of the at least one model.

When the one or more instructions are executed by the at least one first processor individually or collectively according to an embodiment of the disclosure, the image processing apparatus may control the second processor to assign the resources of the second processor to the at least one model, based on the identification information about the at least one model and the resource distribution proportion information of the second processor for the at least one model.

When the one or more instructions are executed by the at least one first processor individually or collectively according to an embodiment of the disclosure, the image processing apparatus may obtain the storage location information for the parameter dataset of the at least one model from among the parameter datasets for the pre-stored plurality of models, based on the identification information about the at least one model.

When the one or more instructions are executed by the at least one first processor individually or collectively according to an embodiment of the disclosure, the image processing apparatus may load the parameter dataset of the at least one model from among the parameter datasets for the pre-stored plurality of models, based on the storage location information for the parameter dataset.

A plurality of model sets each including a combination of the at least one model, according to an embodiment of the disclosure, may be respectively mapped to a plurality of quality intervals in the quality statistic data and pre-stored.

When the one or more instructions are executed by the at least one first processor individually or collectively according to an embodiment of the disclosure, the image processing apparatus may identify a quality interval corresponding to the quality value of the input image, from the identified quality statistic data.

When the one or more instructions are executed by the at least one first processor individually or collectively according to an embodiment of the disclosure, the image processing apparatus may obtain model set information mapped to the identified quality interval and pre-stored.

The plurality of model sets mapped to the quality statistic data, according to an embodiment of the disclosure, may each include one or more models combined to have a same image processing function, and the combined one or more models may have different resource distribution proportions.

When the one or more instructions are executed by the at least one first processor individually or collectively according to an embodiment of the disclosure, the image processing apparatus may store each of a plurality of pieces of quality statistic data for each extended display identification data (EDID) of a device physically connected to the image processing apparatus and for each wireless connection type of a device connected to the image processing apparatus.

When the one or more instructions are executed by the at least one first processor individually or collectively according to an embodiment of the disclosure, the image processing apparatus may periodically or aperiodically update each of the plurality of pieces of quality statistic data when an image is received through the input source.

The determined resource distribution interval according to an embodiment of the disclosure may indicate an interval in which the input image is not output.

An entry time point of the determined resource distribution interval, according to an example embodiment of the disclosure, may include at least one of a screen mute time point or a time point when an advertisement image is output, wherein the screen mute time point includes at least one of an input source change time point, an input channel change time point, or a resolution change time point of the input image.

When the one or more instructions are executed by the at least one first processor individually or collectively according to an embodiment of the disclosure, the image processing apparatus may, when the input source is a motion-focused channel, select a model set in which a resource distribution proportion for a motion estimation model is a selected value or more.

When the one or more instructions are executed by the at least one first processor individually or collectively according to an embodiment of the disclosure, the image processing apparatus may, when the input source is a color-focused channel, select a model set in which a resource distribution proportion for a color correction model is a selected value or more.

When the one or more instructions are executed by the at least one first processor individually or collectively according to an embodiment of the disclosure, the image processing apparatus may, when the input source is a sharpness-focused channel, selects a model set in which a resource distribution proportion for an upscaling model is a selected value or more.

When the one or more instructions are executed by the at least one first processor individually or collectively according to an embodiment of the disclosure, the image processing apparatus may, when the input source corresponds to a set-top box, select a model set in which the resource distribution proportion for the upscaling model is greater than the resource distribution proportion for the motion estimation model.

When the one or more instructions are executed by the at least one first processor individually or collectively according to an embodiment of the disclosure, the image processing apparatus may, when the input source corresponds to a gaming console device, select a model set in which the resource distribution proportion for the motion estimation model is greater than the resource distribution proportion for the upscaling model.

When the one or more instructions are executed by the at least one first processor individually or collectively according to an embodiment of the disclosure, the image processing apparatus may, when a network speed of streaming content corresponding to the input image is less than a selected speed, select a model set in which the resource distribution proportion for the upscaling model is a selected value or more.

When the one or more instructions are executed by the at least one first processor individually or collectively according to an embodiment of the disclosure, the image processing apparatus may, when the network speed of the streaming content corresponding to the input image corresponds to the selected speed, select a model set in which the resource distribution proportion for the upscaling model is less than the selected value.

When the one or more instructions are executed by the at least one first processor individually or collectively according to an embodiment of the disclosure, the image processing apparatus may, when the input image is low quality, select a model set in which resources are distributed to a first upscaling model in which an input resolution and an output resolution correspond to an resolution of the input image.

When the one or more instructions are executed by the at least one first processor individually or collectively according to an embodiment of the disclosure, the image processing apparatus may, when the input image is high quality, select a model set in which resources are distributed to a second upscaling model in which an input resolution corresponds to the resolution of the input image and an output resolution corresponds to a target resolution.

When the one or more instructions are executed by the at least one first processor individually or collectively according to an embodiment of the disclosure, the image processing apparatus may, when a confidence level of the quality statistic data corresponding to the input source of the input image is low, determine to learn at least one model included in the obtained model set.

When the one or more instructions are executed by the at least one first processor individually or collectively according to an embodiment of the disclosure, the image processing apparatus may control the second processor to perform parameter updates on the at least one model to which the resources of the second processor are assigned according to a resource distribution proportion.

When the one or more instructions are executed by the at least one first processor individually or collectively according to an embodiment of the disclosure, the image processing apparatus may control the second processor to generate the output image by performing image processing on the input image through the updated at least one model.

A method of operating an image processing apparatus, according to an example embodiment of the disclosure, includes obtaining input source information and a quality value of an input image, identifying quality statistic data corresponding to the input source information of the input image from among a plurality of pieces of quality statistic data indicating an accumulated frequency according to quality of an image input for each input source, obtaining information about at least one model for image processing, pre-stored in the identified quality statistic data, during a determined resource distribution interval, controlling a second processor to assign resources of the second processor to the at least one model, based on the information about the at least one model, based on the information about the at least one model, loading, onto the second processor, a parameter dataset of the at least one model from among parameter datasets for a pre-stored plurality of models, and obtaining an output image obtained by image-processing the input image, through the at least one model executed by the second processor.

The controlling of the second processor to assign the resources of the second processor to the at least one model, based on the information about the at least one model, according to an embodiment of the disclosure, may include controlling the second processor to assign the resources of the second processor to the at least one model, based on identification information about the at least one model and resource distribution proportion information of the second processor for the at least one model.

The loading of, onto the second processor, the parameter dataset of the at least one model from among parameter datasets for the pre-stored plurality of models, based on the information about the at least one model, according to an embodiment of the disclosure, may include obtaining storage location information for the parameter dataset of the at least one model from among the parameter datasets for the pre-stored plurality of models, based on the identification information about the at least one model, and loading the parameter dataset of the at least one model from among the parameter datasets for the pre-stored plurality of models, based on the storage location information for the parameter dataset.

A plurality of model sets each including a combination of the at least one model, according to an embodiment of the disclosure, may be respectively mapped to a plurality of quality intervals in the quality statistic data and pre-stored.

The obtaining of the information about at least one model pre-stored in the identified quality statistic data, according to an embodiment of the disclosure, may include identifying a quality interval corresponding to the quality value of the input image, from the identified quality statistic data, and obtaining model set information mapped to the identified quality interval and pre-stored.

The operation method according to an embodiment of the disclosure may further include storing each of a plurality of pieces of quality statistic data for each extended display identification data (EDID) of a device physically connected to the image processing apparatus and for each wireless connection type of a device connected to the image processing apparatus, and periodically or aperiodically updating each of the plurality of pieces of quality statistic data when an image is received through the input source.

A non-transitory computer-readable recording medium according to an example embodiment of the disclosure has recorded thereon a program for executing, on a computer, the method of operating an image processing apparatus.

A machine-readable storage medium may be provided in the form of a non-transitory storage medium. Here, the "non-transitory storage medium" denotes a tangible device and may not contain a signal (for example, electromagnetic waves). This term does not distinguish a case where data is stored in the storage medium semi-permanently and a case where the data is stored in the storage medium temporarily. For example, the "non-transitory storage medium" may include a buffer where data is temporarily stored.

According to an embodiment of the disclosure, a method according to various embodiments of the disclosure disclosed in the present disclosure may be provided by being included in a computer program product. The computer program product is a product that can be traded between sellers and buyers. The computer program product may be distributed in the form of a machine-readable storage medium (for example, compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or memory of a relay server.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An image processing apparatus comprising:
memory including at least one storage medium storing one or more instructions;
at least one first processor, comprising processing circuitry, individually and/or collectively, configured to execute the one or more instructions; and
at least one second processor, comprising processing circuitry, individually and/or collectively, configured to perform image processing,
wherein, the one or more instructions, when executed by at least one first processor individually and/or collectively, cause the image processing apparatus to:
obtain input source information and a quality value of an input image;
identify quality statistic data corresponding to the input source information of the input image from among a plurality of pieces of quality statistic data indicating an accumulated frequency according to quality of an image input for each input source;
obtain information about one or more models stored in the identified quality statistic data;
during a determined resource distribution interval, control the at least one second processor to assign resources of the at least one second processor to the one or more models, based on the information about the one or more models;
based on the information about the one or more models, load, onto the at least one second processor, a parameter dataset of the one or more models; and
obtain an output image obtained by image-processing the input image, through the one or more models executed by the at least one second processor.

2. The image processing apparatus of claim 1, wherein the information about the one or more models comprises identification information about the one or more models, resource distribution proportion information of at least one second processor for the one or more models, and/or storage location information for the parameter dataset of the one or more models.

3. The image processing apparatus of claim 2, wherein the one or more instructions, when executed by at least one first processor, individually and/or collectively, cause the image processing apparatus to control at least one second processor to assign the resources of at least one second processor to the one or more models, based on the identification information about the one or more models and the resource distribution proportion information of at least one second processor for the one or more models.

4. The image processing apparatus claim 2, wherein the one or more instructions, when executed by at least one first processor, individually and/or collectively, cause the image processing apparatus to:
obtain the storage location information for the parameter dataset of the one or more models from among parameter datasets for a plurality of models, based on the identification information about the one or more models; and
load the parameter dataset of the one or more models from among the parameter datasets for the plurality of models, based on the storage location information for the parameter dataset.

5. The image processing apparatus of claim 1, wherein a plurality of model sets each including a combination of the one or more models are respectively mapped to a plurality of quality intervals in the quality statistic data and pre-stored, and
the one or more instructions, when executed by at least one first processor, individually and/or collectively, cause the image processing apparatus to:
identify a quality interval corresponding to the quality value of the input image, from the identified quality statistic data; and
obtain model set information mapped to the identified quality interval and pre-stored.

6. The image processing apparatus of claim 5, wherein each of the plurality of model sets mapped to the quality statistic data includes one or more models combined to have a same image processing function, and the combined one or more models have different resource distribution proportions.

7. The image processing apparatus of claim 1, wherein the one or more instructions, when executed by at least one first processor, individually and/or collectively, cause the image processing apparatus to:
store each of a plurality of pieces of quality statistic data for each extended display identification data (EDID) of a device physically connected to the image processing apparatus and for each wireless connection type of a device connected to the image processing apparatus; and
update each of the plurality of pieces of quality statistic data when an image is received through the input source.

8. The image processing apparatus of claim 1, wherein the determined resource distribution interval indicates an interval in which the input image is not output.

9. The image processing apparatus of claim 8, wherein an entry time point of the determined resource distribution interval includes at least one of a screen mute time point or a time point at which an advertisement image is output, wherein the screen mute time point includes at least one of an input source change time point, an input channel change time point or a resolution change time point of the input image.

10. The image processing apparatus of claim 1, wherein the one or more instructions, when executed by at least one first processor, individually and/or collectively, cause the image processing apparatus to:
based on the input source being a motion-focused channel, select a model set in which a resource distribution proportion for a motion estimation model is a selected value or more;
based on the input source being a color-focused channel, select a model set in which a resource distribution proportion for a color correction model is a selected value or more; and
based on the input source being a sharpness-focused channel, select a model set in which a resource distribution proportion for an upscaling model is a selected value or more.

11. The image processing apparatus of claim 1, wherein the one or more instructions, when executed by at least one first processor, individually and/or collectively, cause the image processing apparatus to:
based on the input source corresponding to a set-top box, select a model set in which the resource distribution proportion for the upscaling model is greater than the resource distribution proportion for the motion estimation model; and
based on the input source corresponding to a gaming console device, select a model set in which the resource distribution proportion for the motion estimation model is greater than the resource distribution proportion for the upscaling model.

12. The image processing apparatus of claim 1, wherein the one or more instructions, when executed by at least one first processor, individually and/or collectively, cause the image processing apparatus to:
based on a network speed of streaming content corresponding to the input image being less than a selected speed, select a model set in which the resource distribution proportion for the upscaling model is a selected value or more; and
based on the network speed of the streaming content corresponding to the input image corresponding to the selected speed, select a model set in which the resource distribution proportion for the upscaling model is less than the selected value.

13. The image processing apparatus of claim 1, wherein the one or more instructions, when executed by at least one first processor, individually and/or collectively, cause the image processing apparatus to:
based on the input image being low quality, select a model set in which resources are distributed to a first upscaling model in which an input resolution and an output resolution correspond to a resolution of the input image; and
based on the input image being high quality, select a model set in which resources are distributed to a second upscaling model in which an input resolution corresponds to the resolution of the input image and an output resolution corresponds to a target resolution.

14. The image processing apparatus of claim 1, wherein the one or more instructions, when executed by at least one first processor, individually and/or collectively, cause the image processing apparatus to:
based on a confidence level of the quality statistic data corresponding to the input source of the input image being low, determine to learn one or more models included in the obtained model set;
control the at least one second processor to perform parameter updates on the one or more models to which the resources of the at least one second processor are assigned according to a resource distribution proportion; and
control the at least one second processor to generate the output image by performing image processing on the input image through the updated one or more models.

15. A method of operating an image processing apparatus, comprising:
obtaining input source information and a quality value of an input image;
identifying quality statistic data corresponding to the input source information of the input image from among a plurality of pieces of quality statistic data indicating an accumulated frequency according to quality of an image input for each input source;
obtaining information about one or more models stored in the identified quality statistic data;
during a determined resource distribution interval, controlling at least one second processor to assign resources of the at least one second processor to the one or more models, based on the information about the one or more models;
based on the information about the one or more models, loading, onto the at least one second processor, a parameter dataset of the one or more models; and
obtaining an output image obtained by image-processing the input image, through the one or more models executed by the at least one second processor.

16. The method of claim 15, wherein the controlling of at least one second processor to assign the resources of the at least one second processor to the one or more models, based on the information about the one or more models comprises controlling at least one second processor to assign the resources of the at least one second processor to the one or more models, based on identification information about the one or more models and resource distribution proportion information of at least one second processor for the one or more models.

17. The method of claim 15, wherein the loading of, onto at least one second processor, the parameter dataset of the one or more models, based on the information about the one or more models comprises:
obtaining storage location information for the parameter dataset of the one or more models from among parameter datasets for a plurality of models, based on the identification information about the one or more models; and
loading the parameter dataset of the one or more models from among the parameter datasets for the plurality of models, based on the storage location information for the parameter dataset.

18. The method of claim 15, wherein a plurality of model sets each including a combination of the one or more models are respectively mapped to a plurality of quality intervals in the quality statistic data and pre-stored, and
the obtaining of the information about the one or more models stored in the identified quality statistic data comprises:
identifying a quality interval corresponding to the quality value of the input image, from the identified quality statistic data; and
obtaining model set information mapped to the identified quality interval and pre-stored.

19. The method of claim 15, further comprising:
storing each of a plurality of pieces of quality statistic data for each extended display identification data (EDID) of a device physically connected to the image processing apparatus and for each wireless connection type of a device connected to the image processing apparatus; and
updating each of the plurality of pieces of quality statistic data based on an image being received through the input source.

20. A non-transitory computer-readable recording medium having recorded thereon a program which, when executed on a computer, of an image processing apparatus, causes the image processing apparatus to perform the method of claim 15.
